(19) United States
(12) Patent Application Publication
(10) Pub. No.: US 2026/0149516 A1
(43) Pub. Date: May 28, 2026

(54) METHOD AND SYSTEM FOR 3D IOD-TO-VEHICLE COMMUNICATION BY VANET

(71) Applicant: King Fahd University of Petroleum and Minerals, Dhahran (SA)

(72) Inventors: Gamil Abdullah Mohsen AHMED, Dhahran (SA); Tarek Rahil Omar SHELTAMI, Dhahran (SA); Ashraf Sharif Hasan MAHMOUD, Dhahran (SA); Ansar UlHaque YASAR, Lubbeek (BE)

(73) Assignee: King Fahd University of Petroleum and Minerals, Dhahran (SA)

(21) Appl. No.: 19/253,072

(22) Filed: Jun. 27, 2025

Related U.S. Application Data
(60) Provisional application No. 63/725,359, filed on Nov. 26, 2024.

(51) Int. Cl. H04B 17/391; H04B 7/026; H04B 17/318; H04W 64/00

(52) U.S. Cl. CPC H04B 17/3912; H04B 17/318; H04W 64/00; H04B 7/026

(57) ABSTRACT

A terrestrial communication on a three-dimensional internet of drone (IoD)-assisted vehicle ad-hoc network including a plurality of drones and a plurality of vehicles system and method is disclosed. The method includes obtaining first geographical coordinates of each vehicle of the plurality of vehicles and estimating a first elevation of each vehicle of the plurality of vehicles at the first geographical coordinates. The method involves obtaining second geographical coordinates for each drone in a plurality of drones, detecting obstacles between vehicles, determining signal attenuation using a propagation module, and evaluating signal attenuation using an objective function to determine target coordinates for each drone. It also detects obstacles between vehicles using the first and second coordinates and uses a propagation module to determine the signal attenuation. The method includes deploying the plurality of drones based on the target coordinates and facilitating the terrestrial communication on the three-dimensional IoD-assisted vehicle ad-hoc network.

### CROSS-REFERENCE TO RELATED APPLICATIONS

The present application claims priority to U.S. Provisional Application No. 63/725,359, filed Nov. 26, 2024, the entire content of which is incorporated by reference herein in its entirety for all purposes.

### STATEMENT OF PRIOR DISCLOSURE BY AN INVENTOR

Aspects of the present disclosure were described in Ahmed, G., Sheltami, T., Mahmoud, A. & Yasar, A. 3D Simulation Model for IoD-to-Vehicles Communication in IoD-Assisted VANET. Front. Built Environ. 9, 1-18 (2023), incorporated herein by reference in its entirety.

### BACKGROUND

### Technical Field

The present disclosure is directed to a terrestrial communication, and more particularly, to systems and methods for three-dimensional (3D) Internet of Devices (IoD)-assisted vehicle ad-hoc network (VANET) that enables the navigation of vehicles to overcome terrain obstacles, maintain clear sight lines, and improve signal quality.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The integration of the Internet of Devices (IoD) into vehicle ad-hoc networks (VANETs) can enhance communication between vehicles and surrounding infrastructure. As transportation systems evolve, the demand for real-time data communication between vehicles, road infrastructure, and other connected devices has surged, driven by the increasing need for safety, efficiency, and automation in smart cities. VANETs, a type of mobile ad-hoc network (MANET), are designed to enable communication between vehicles, allowing them to share information about road conditions, traffic, and hazards in real-time.

However, despite their significant potential, VANETs still face some challenges. One such challenge is the network disconnection that occurs due to the mobility of vehicles. As vehicles travel at high speeds, the network connectivity between them can become unstable, leading to intermittent communication and delays. This can hinder the effectiveness of VANETs, particularly in situations where timely information sharing is essential for safety.

The IoD is becoming a preferred solution to address challenges in Vehicle-to-Vehicle (V2V) and Vehicle-to-Infrastructure (V2I) networks. IoT can provide additional data sources and communication channels, enhancing network robustness and reliability. However, 3D simulation models can simulate the interaction between IoD devices and vehicles in VANETs. These models aid researchers and practitioners in comprehending the interplay between various devices in a dynamic environment, thereby identifying potential vulnerabilities and enhancing network performance.

Current research in the field of VANETs focuses on improving communication reliability and network stability. Some strategies have been proposed to overcome the challenges posed by the mobility of vehicles and the intermittent nature of wireless communication. One of the areas of focus is the development of robust communication protocols that can handle frequent disconnections and re-connections as vehicles move in and out of range.

Research has focused on designing intelligent routing protocols for vehicle autonomous networks (VANs) to optimize data transmission paths, considering factors like vehicle density, road conditions, and communication node location. Some protocols prioritize close-proximity communication, while others focus on infrastructure-based communication for connectivity in low-vehicle-density areas. The integration of IoD with VANETs can be considered for enhancing system performance.

IoD can contribute to VANETs by providing additional data streams from sensors, traffic signals, and environmental monitoring devices. These data sources can help vehicles make more informed decisions, such as adjusting speed in response to road conditions or avoiding accidents by receiving early warnings about nearby hazards.

Simulation models can assess the performance of VANETs and IoD-assisted communication systems, enabling researchers to simulate driving scenarios and test protocols, as well as analyze the impact of network interruptions. 3D simulation models are particularly effective in visualizing the interaction between vehicles and IoD devices in real-world environments.

Research is focusing on developing hybrid communication models that combine infrastructure-based and vehicle-based communication strengths, offering flexibility and reliability in maintaining network connectivity. These models balance benefits of roadside infrastructure with direct communication between vehicles, such as traffic signals.

Accordingly, it is one object of the present disclosure to provide a method and a system for IoD-assisted VANETs that allow vehicles to navigate through terrain obstacles, maintain clear sight lines, and enhance signal quality.

### SUMMARY

In an exemplary embodiment method for a terrestrial communication on a three-dimensional internet of drone (IoD)-assisted vehicle ad-hoc network including a plurality of drones and a plurality of vehicles is disclosed. The method includes obtaining first geographical coordinates of each vehicle of the plurality of vehicles. The method is further configured to estimating a first elevation of each vehicle of the plurality of vehicles at the first geographical coordinates. The method is further configured to obtaining second geographical coordinates of each drone of the plurality of drones. The method is further configured to detecting one or more obstacles between a first vehicle of the plurality of vehicles and a second vehicle of the plurality of vehicles based on the geographical coordinates and the first elevation. The method is further configured to determining a signal attenuation based on the first geographical coordinates, the second geographical coordinates, and the one or more obstacles with a propagation module. The method is further configured to evaluating the signal attenuation based on an objective function to determine target coordinates of each drone of the plurality of drones. The method is further configured to deploying the plurality of drones based on the target coordinates. The method is further configured to facilitating the terrestrial communication on the three-dimensional IoD-assisted vehicle ad-hoc network. The method is further configured to the propagation module includes a single knife-edge propagation model. The method is further configured to the single-knife edge propagation model determines the signal attenuation based on a Fresnel-Kirchhoff diffraction parameter. The method is further configured to the method is repeated as the first geographical coordinates of the plurality of vehicles change. The method is further configured to the facilitating the terrestrial communication further comprises facilitating communication between the plurality of vehicles and the plurality of drones, the plurality of drones acting as relay nodes. The method is further configured to propagation module determines received signal strength at the plurality of vehicles by accounting for signal attenuation caused by terrain features. The method is further configured to adjusting the target coordinates of the plurality of drones in real-time based on movement of the plurality of vehicles to maintain optimal terrestrial communication coverage. The method is further configured to adjusting the target coordinates of the plurality of drones in real-time based on changes to the one or more obstacles to maintain optimal terrestrial communication coverage. The method is further configured to determining, using a machine learning model, updated first geographical coordinates of the each vehicle of the plurality of vehicles and adjusting the target coordinates of the plurality of drones in real-time based on the updated first geographical coordinates of each vehicle of the plurality of vehicles. The method is further configured to the evaluating the signal attenuation based on the objective function further includes obtaining a received signal strength indicator (RSSI) at a receiving vehicle and determining a terrestrial communication coverage based on the RSSI and the target coordinates of each drone of the plurality of drones. The method is further configured to the evaluating the signal attenuation based on the objective function further includes setting a minimum power-level threshold, determining the terrestrial communication coverage based on the RSSI and the minimum power-level threshold, further a vehicle of the plurality of vehicles is defined as covered when the RSSI is greater than the minimum power-level threshold. The method is further configured to terrain elevation data including the first elevation of the each vehicle of the plurality of vehicles is obtained from a digital elevation model (DEM) to define a terrain profile. The method is further configured to adjusting the target coordinates of the each drone of the plurality of drones based on line-of-sight (LoS) and non-line-of-sight (NLoS) conditions. The method is further configured to further comprising adjusting elevations of the plurality of drones to balance a trade-off between improved LoS conditions and increased path loss due to greater distances between each drone of the plurality of drones and the each vehicle of the plurality of vehicles. The method is further configured to dividing a LoS between a drone of the plurality of drones and a vehicle of the plurality of vehicles into a plurality of prediction points to detect the one or more obstacles affecting signal propagation. The method is further configured to the determined target coordinates of each drone of the plurality of drones is adjusted to account for a varying density of the plurality of vehicles.

In an exemplary embodiment system of a three-dimensional internet of drone (IoD)-assisted vehicle ad-hoc network is disclosed here. The system includes a vehicle mobility module. The system is further configured to an IoD deployment module communicatively connected to the vehicle mobility module. The three-dimensional propagation module includes an elevation estimation module. The three-dimensional propagation module includes an obstacle detection module. The three-dimensional propagation module includes a single knife-edge propagation module. The three-dimensional propagation module includes processing circuitry configured to perform the method that includes the three-dimensional propagation module is communicatively connected to the IoD deployment module and the vehicle mobility module. The system is further configured to the single-knife edge propagation model determines the signal attenuation based on a Fresnel-Kirchhoff diffraction parameter. The system is further configured to method is repeated as the first geographical coordinates of the plurality of vehicles change. The system is further configured to the propagation module determines received signal strength at the plurality of vehicles by accounting for signal attenuation caused by terrain features.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates three-dimensional internet of drone (3D IoD)-assisted vehicle ad hoc networks (VANET) communication architecture, according to certain embodiments.

FIG. 2 illustrates a 3D IoD-assisted VANET system framework, according to certain embodiments.

FIG. 3 illustrates a digital elevation module (DEM) data structure, according to certain embodiments.

FIG. 4 is a 3D view of Al-Hada Road from a DEM file, according to certain embodiments.

FIG. 5 is an illustration of a division of line of sight (LoS) into Prediction Points for Obstacle Detection (PPOD), according to certain embodiments.

FIG. 6 is an improved particle swarm optimization (IPSO) flow chart for 3D-IoD-assisted VANET description, according to certain embodiments.

FIG. 7A is an illustration of average normalized coverage vs. simulation time for the IoD deployment altitudes in 2D and 3D modules for 50 meters, according to certain embodiments.

FIG. 7B is an illustration of average normalized coverage vs. simulation time for the IoD deployment altitudes in 2D and 3D modules for 200 m, according to certain embodiments.

FIG. 8A is an illustration of the average RSSI vs. simulation time for the IoD at 50 m altitudes in two-dimensional (2D) and 3D propagation modules, according to certain embodiments.

FIG. 8B is an illustration of the average received signal strength indicator (RSSI) vs. simulation time for the IoD at 200 m altitudes in 2D and 3D propagation modules, according to certain embodiments.

FIG. 9A is an illustration of average normalized coverage for different IoD deployment altitudes, according to certain embodiments.

FIG. 9B is an illustration of an average RSSI for different IoD deployment altitudes, according to certain embodiments.

FIG. 10A is an illustration of unmanned aerial vehicles (drone) trajectories of 2D vs 3D propagation modules, according to certain embodiments.

FIG. 10B is an illustration of an altitude variation of 2D vs 3D propagation module, according to certain embodiments.

FIG. 11A is an illustration of an average normalized coverage for different IoD sizes in the 3DIoDAV, according to certain embodiments.

FIG. 11B is an illustration of the RSSI for different IoD sizes in IoD collaborative communication approach for efficient VANET assistance (3DIoDAV), according to certain embodiments.

FIG. 12A is an illustration of a normalized coverage across transmission powers and the IoD sizes in the 3DIoDAV at 50-100 m altitude according to certain embodiments.

FIG. 12B is an illustration of a normalized coverage across transmission powers and the IoD sizes in the 3DIoDAV at 100-150 m altitude, according to certain embodiments.

FIG. 13A is an illustration of an average RSSI for different transmission power values with respect to different IoD sizes in 3DIoDAV at 50-100 m deployment altitude, according to certain embodiments.

FIG. 13B is an illustration of an average RSSI for different transmission power values with respect to different IoD sizes in the 3DIoDAV at 100-150 m deployment altitude, according to certain embodiments.

FIG. 14A is an illustration of an average normalized coverage for different IoD sizes in the 3DIoDAV, 2D, and IoDAV approaches at 50-100 m deployment altitude, according to certain embodiments.

FIG. 14B is an illustration of an average normalized coverage for different IoD sizes in the 3DIoDAV, 2D, and IoDAV approaches at 100-150 m deployment altitude, according to certain embodiments.

FIG. 15A is an illustration of an average RSSI for different sets of drones in the 3DIoDAV, 2D, and IoDAV approaches at 50-100 m deployment altitude, according to certain embodiments.

FIG. 15B is an illustration of an average RSSI for different sets of drones in the 3DIoDAV, 2D, and IoDAV approaches at 100-150 m deployment altitude, according to certain embodiments.

FIG. 16A is an illustration of an average normalized coverage in the 3DIoDAV, 2D, and IoDAV approaches for different transmission power values for 10 drones at 50-100 m deployment altitude, according to certain embodiments.

FIG. 16B is an illustration of an average normalized coverage in the 3DIoDAV, 2D, and IoDAV approaches for different transmission power values for 10 drones at 100-150 m deployment altitude, according to certain embodiments.

FIG. 17A is an illustration of a 2D and 3D IoD deployment evaluated by 3DIoDAV for different sets of drones for average normalized coverage, according to certain embodiments.

FIG. 17B is an illustration of a 2D and 3D IoD deployment evaluated by 3DIoDAV for different sets of drones for average RSSI, according to certain embodiments.

FIG. 18 is an illustration of a non-limiting example of details of computing hardware used in a computing device, according to certain embodiments.

FIG. 19 is an exemplary schematic diagram of a data processing system used within the computing device, according to certain embodiments.

FIG. 20 is an exemplary schematic diagram of a processor used with the computing device, according to certain embodiments.

FIG. 21 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed towards communication module for Internet of Drone to Vehicles (IoD2V) communication for improving communication between ground vehicles in a vehicular ad hoc network (VANET) with the assistance of Unmanned Aerial Vehicles (UAVs), also referred to as drones. VANETs, which are networks formed by vehicles and infrastructure, can benefit from the advantages provided by drone mobility. One challenge includes the lack of consideration for how terrain features, such as hills and mountains, can impact communication between the IoD and the VANET, which can block signals and affect the network's performance. The challenges faced in incorporating terrain and drones in modules are often using only one drone in a simple scenario with few vehicles. This lack of consideration for the flexibility and mobility of drones, a key strength of the IoD, and the lack of flexibility in deployment, where multiple drones can cover wide areas and adjust their positions dynamically, has been area of further improvement.

The present disclosure provides an IoD2V communication module that focuses on improving communication quality between ground vehicles in VANETs by allowing flexible deployment of drones as relay nodes. The flexible deployment of drones overcomes or mitigate signal attenuation issues caused by terrain obstacles like hills, mountains, or tall buildings. The IoD2V module addresses terrain impact by introducing multiple drones that can fly and be deployed dynamically, overcoming limitations posed by terrain. For instance, in mountainous regions, if a vehicle is isolated due to a mountain, the IoD network can dispatch a drone to act as mobile relay stations, connecting the isolated vehicle with others. Terrain can cause signal attenuation, such as in valleys where hills block the signal between two vehicles. Drones, with their ability to move freely in the air, can fly over these obstacles, creating a communication line.

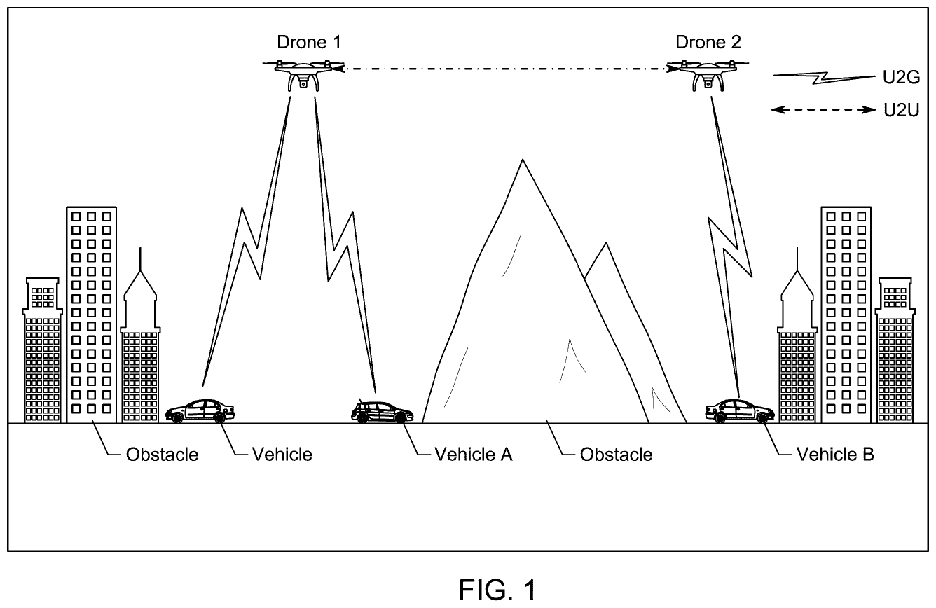

FIG. 1A illustrates a three-dimensional internet of drone collaborative communication approach for efficient VANET assistance (3DIoDAV) architecture that integrates drones into IoD and VANET networks, allowing vehicles to follow their paths and maintain communication even when terrain obstacles block direct communication.

The 3DIoDAV architecture combines drone (IoD networks) and VANETs to ensure robust communication, even in terrain obstacles. The VANET vehicles move along paths, such as highways or city roads, while drones act as relay nodes, deployed in the air to maintain communication between vehicles when direct communication is obstructed. For instance as shown in FIG. 1, if two vehicles (Vehicle A and Vehicle B) need to communicate but an obstacle such as a hill is in between, the drones (for example, a drone 1 and a drone 2) are deployed above the hill to act as communication bridges, allowing the vehicles to maintain a communication link despite the mountain's physical obstruction. As shown in FIG. 1, the vehicle A and the drone 1 are communicatively coupled to each other through a UAV-to-Ground (U2G) communication mode, while the drone 1 and the drone 2, serving as a bridge, are communicatively coupled through UAV-to-UAV (U2U) communication mode. Similarly, the drone 2 and the vehicle B are communicatively coupled to each other through the U2G communication mode, completing the communication link between the vehicle A and the vehicle B. The U2G may refer to the communication mode between UAVs (such as the drones) and ground-based infrastructure or vehicles. There may be multiple exemplary implementations in the U2G communication mode implementations, such as UAV to vehicle, UAV to roadside units (RSU), and UAV to base stations. Also, there may be multiple exemplary implementations in the U2U communication mode implementations, such as swarm communication mode and data relay and forwarding communication mode.

In an embodiment of the present disclosure, the drones, due to their flexibility and mobility, serve as relays, maintaining communication even when direct communication is blocked. The drone deployment optimizes communication by periodically updating their locations based on the vehicle movements and received signal strength (RSS).

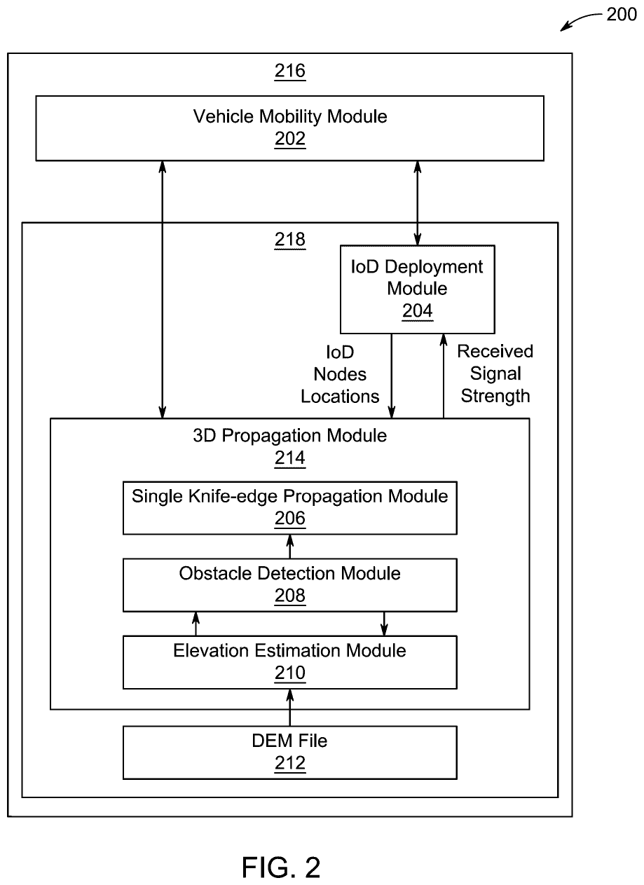

In an embodiment, 3D propagation module 214 (shown in FIG. 2) is a platform that is configured to characterize communication between the drones (hereinafter interchangeably referred to as IoD nodes) and the vehicles, considering the impact of the terrain on signal propagation. The 3D propagation module 214 determines how the drones can bridge communication gaps between vehicles communication blocked by obstacles like hills, buildings, and the like.

According to an embodiment, the drone deployment is dynamic in nature, where the drones are deployed based on real-time conditions. For example, the positions of the drones are adjusted as the vehicles move along their paths. The dynamic deployment is performed to provide uninterrupted signal coverage, even when vehicles are further apart, or new obstacles appear. For example, when signal strength weakens, the IoD nodes are moved to new positions to maintain communication between the vehicles.

In an embodiment of the present disclosure, the deployment of drones is optimized using a framework that considers real-time vehicle locations and RSS state. For example, the drones and other vehicles (ground units or additional drones) are tracked in real-time using a Global Positioning System (GPS), Inertial Measurement Unit (IMU) sensors, or onboard positioning systems. The RSS state is continuously measured based on signals received from communication nodes (e.g., base stations, IoT devices, or other drones). There may be additional environmental factors such as obstacles, weather, and interference, which may also be considered. Using the real-time vehicle location and the RSS state, the system performs optimal placement to minimize the distance between the drones and the vehicles. In instances where a vehicle loses connection, the drones are moved or dispatched to cover the gap, to improve effectiveness and reconnection. In an embodiment, the IoD2V communication module addresses signal disruption in the VANETs by introducing the drones as mobile relay stations that bridge communication gaps. These drones dynamically adjust their positions based on real-time vehicle locations and signal strength and use the 3D propagation module to predict how terrain features affect signal quality. In remote areas, the drones equipped with wireless communication capabilities can provide continuous communication between vehicles, enabling them to share traffic updates or emergency information. For example, in remote areas, the drones can establish communication between stranded vehicles and emergency responders, overcoming terrain obstacles.

The present disclosure describes an optimization framework for enhancing the connectivity of VANET in 3D space by strategically deploying IoD nodes at optimal positions. The optimization framework uses a 3D propagation module integrated into the Improved Particle Swarm Optimization (IPSO) algorithm. The optimization framework is to improve VANET connectivity in 3D space by strategically positioning IoD nodes at optimal locations. Such strategic positioning ensures continuous communication between the vehicles, even in challenging terrains like mountainous areas with high hills or valleys. By strategically placing IoD nodes at optimal heights, even in areas where direct line-of-sight communication is blocked, vehicles can maintain connectivity to the VANET, ensuring a more efficient and reliable network.

To test the implementation of system, the disclosure uses simulation tools like OMNET++ (OMNET++ (Objective Modular Network Testbed in C++) is maintained and further developed by OpenSim Ltd, located at Houston, Texas, United States of America), Veins (Vehicles in Network Simulation, an open-source framework used for simulating VANETs), and SUMO (Simulation of Urban Mobility) in designing complex transportation networks. OMNET++is a detailed and customizable environment for designing network topologies, similar to a transportation network. Veins is an extension that connects OMNET++with SUMO, which simulates vehicle movements. Veins may simulate how vehicles interact with the network as they move along a route. SUMO, on the other hand, simulates vehicle traffic patterns, tracking the positions and movements of thousands of cars. For real-time scenarios, SUMO is used to simulate traffic flows in a city, including vehicle speeds and routes. By integrating SUMO with Veins and OMNET++, it can be determined where to place IoD nodes to maintain communication between vehicles in different parts of the city. The implementation of the system is described in detail in FIG. 2.

FIG. 2 explains 3D IoD-assisted vehicle ad hoc networks (3DIoDAV) system framework 200 that facilitates terrestrial communication in the three-dimensional IoD-assisted VANET. The 3DIoDAV system framework 200 includes vehicle mobility module 202, an IoD deployment module 204, a 3D propagation module 214 and a digital elevation module (DEM) file 212. The vehicle mobility module 202 is a communication module deployed in vehicles such as two wheels, four wheels, trucks, and the like. The vehicle mobility module 202 may be configured as a network node equipped with various components to enable communication, sensing, and decision-making. These components (collectively referred to as the vehicle mobility module 202) help vehicles exchange data with other vehicles (vehicle-to-vehicle (V2V)), infrastructure (vehicle-to-infrastructure (V2I)), pedestrians (vehicle-to-pedestrian (V2P)), and the cloud (vehicle-to-cloud (V2C)). The vehicle mobility module 202 may use dedicated short-range communication (DSRC), 5G C-V2X (Cellular Vehicle-to-Everything), Wi-Fi and/or Bluetooth, satellite communication, and the like.

The vehicle mobility module 202 may use a GPS to identify accurate locations and speed of the vehicle, Light Detection and Ranging (LiDAR), radar, cameras and/or ultrasonic sensors to aid in communication. Furthermore, the vehicle mobility module 202 may include on-board processing and computing units, an electronic control unit (ECU), an On-Board Unit (OBU), edge computing and AI processors for enabling communication in VANET, processing data and real-time decision-making, route optimization, and/or hazard detection. The vehicle mobility module 202 may be powered by a battery management system (BMS) of the vehicle. The vehicle mobility module 202 is coupled to the IoD deployment module 204.

The IoD deployment module 204 is configured to manage deployment of IoD nodes, enhancing signal strength and vehicle coverage. Each of the drones may be referred to as an IoD node. The IoD deployment module 204 is configured to communicatively couple drones to vehicles to enhance transportation systems, traffic monitoring, and emergency response. The IoD deployment module 204 deploys drones to communicate with vehicles, roadside units (RSUs), and cloud servers to optimize mobility, safety, and decision-making in intelligent transportation systems (ITS). The IoD deployment module 204 includes processor, memory, circuitry and communication protocols to optimally place drones to support VANET to enable communication with connected vehicles using, for example, V2U (Vehicle-to-UAV) protocols. The IoD deployment module 204 may be configured to achieve optimization of the deployment of IoD notes through the use of geographical data handling, vehicle mobility data, and signal calculation. In examples, the IoD deployment module 204 may use the DEM file 212 to obtain terrain elevation data for geographical data handling. In aspects, the DEM file 212 is a digital representation of terrain elevation data. The DEM file includes 3D elevation values of the Earth's surface, represented in, for example, a grid format. The IoD deployment module 204 tracks vehicle mobility data based on data obtained from the vehicle mobility module(s) 202. In examples, the vehicle mobility data is tracked in real-time or near real-time.

In an instance, in a city with tall buildings, and highways, rural outskirts, real-time traffic data and elevation data is used by the IoD deployment module 204 to optimize IoD node placement, ensuring vehicle connectivity in urban areas. In aspects, the IoD deployment module 204 may use wireless communication. In examples, wireless technologies may include such as 4G, 5G, 6G, and the like. Having uninterrupted terrestrial communication due to the vehicle, speed at which different vehicles travel, tall buildings, hills and mountains, environmental constraints and different terrains, may have their challenges. The IoD deployment module 204 allows communication with the ground vehicle at any point in time. The IoD deployment module 204 receives the current location of the ground vehicle and deploys the drones to the appropriate location such that vehicle connectivity is maintained.

The 3D propagation module 214 includes a single knife-edge propagation module 206, an obstacle detection module 208, and an elevation estimation module 210. The elevation estimation module 210 is configured to obtain access and obtain information from the DEM file 212. Elevation estimation information related to terrain may be available in the DEM file 212. To estimate the elevation of a given coordinates sent by the DEM file 212, the elevation estimation module 210 queries or obtains the elevation information corresponding to the given coordinates from the DEM file 212. The terrain elevation data includes a first elevation of each vehicle of the plurality of vehicles obtained DEM that defines a terrain profile.

The elevation estimation module 210 communicates the elevation information of the given coordinates to the obstacle detection module 208. The obstacle detection module 208 identifies any obstacles between a sender (vehicle) and receiver (vehicle) based on sender and receiver locations. For example, when two vehicles are in communication, there might be a disruption in the signal due to obstacles present around them. In order to have uninterrupted communication, the obstacles that cause disruption may be detected by the obstacle detection module 208 using, for example, the elevation information. The obstacle detection module 208 may communicate identified information on obstacles and their maximum heights corresponding to the elevation to the 3D propagation module 214. The 3D propagation module 214 receives the second locations of IoD nodes from IoD deployment module 204 and communicates a received signal strength information (RSSI) to IoD deployment module 204.

In operation, the 3D propagation module 214 receives the first geographical coordinates of each vehicle of the plurality of vehicles through corresponding vehicle mobility module(s) 202. The elevation estimation module 210 estimates the first elevation of each vehicle of the plurality of vehicles at the first geographical coordinates. In examples, the first elevation data may be obtained from terrain elevation data. The DEM file 214 includes the terrain elevation data. The IoD deployment module 204 obtains the second geographical coordinates of each drone of the plurality of drones. In some aspects, the IoD deployment module 204 may have deployed the drones at defined geographical coordinates. In aspects, if there are obstacles between a first vehicle of the plurality of vehicles and a second vehicle of the plurality of vehicles, the obstacle detection module 208 is configured to detect the one or more obstacles based on the geographical coordinates and the first elevation. For example, the obstacles may include but are not limited to buildings, hills, boulders, and the like. The 3D propagation module 214 is configured to determine the signal attenuation based on the first geographical coordinates, the second geographical coordinates and the one or more obstacles. In aspects, the signal attenuation may be determined based on one or more signal attenuation determination techniques. Some examples of signal attenuation determination techniques include, but are not limited to, path loss models, obstacle effects (reflection, refraction, absorption, etc.), elevation data (from DEM file 214, etc.), and environmental factors. In examples, the 3D propagation module 214 includes a single knife-edge propagation module 206 that operates using a single knife-edge propagation model. In examples, by using Fresnel-Kirchhoff diffraction parameter, the single-knife edge propagation model determines the signal attenuation. Based on the different terrain features, such as tall buildings and environmental constraints, there may be varying signal attenuation. In aspects, the 3D propagation module 214 determines received signal strength at the plurality of vehicles at the plurality of vehicles by accounting for signal attenuation caused by terrain features.

The 3D propagation module 214 evaluates the signal attenuation based on an objective function to determine target coordinates of each drone of the plurality of drones. To evaluate the signal attenuation based on the objective function, the 3D propagation module 214 obtains a received signal strength indicator at a receiving vehicle. Further, the 3D propagation module 214 determines a terrestrial communication coverage based on the RSSI and the target coordinates of each drone of the plurality of drones. In examples, the 3D propagation module 214 may set a minimum power-level threshold. The minimum power-level threshold may be a lowest RSSI required for stable communication. In examples, the minimum power-level threshold may be −85 dBm in urban terrain with a distance of 500 meters. In another example, the minimum power-level threshold may be −95 dBm with a distance of 1000 meters. For the line-of-sight communication, the minimum power-level threshold may be −75 dBm with a distance of 1000 meters. For non-line-of-sight communication, the minimum power-level threshold may be −95 dBm for a distance of 300 meters. Below the minimum power-level threshold, there may be packet loss and communication may become unreliable. The 3D propagation module 214 determines the terrestrial communication coverage based on the RSSI and the minimum power-level threshold, where the vehicle of the plurality of vehicles is defined as covered when the RSSI is greater than the minimum power-level threshold.

The 3D propagation module 214 evaluates the signal attenuation based on the objective function by setting a minimum power-level threshold. If the RSSI is greater than the minimum power-level threshold, it defines the vehicle of the plurality of vehicles are covered by the network. In case, the signal attenuation based on the objective function is below threshold, the 3D propagation module 214 communicates the lack of RSSI to the IoD deployment module 204. The IoD deployment module 204 deploys the plurality of drones based on the target coordinates. By deploying the plurality of drones based on the target coordinates, the IoD deployment module 204 facilitates the terrestrial communication on the three-dimensional IoD-assisted vehicle ad-hoc network, which includes facilitating communication between the plurality of vehicles and the plurality of drones.

In some aspects, the vehicles may be moving, leading to a change of the first geographical coordinates. The 3DIoDAV system framework 200 is configured to continuously monitor the change of the first geographical coordinates and deploy the plurality of drones based on the updated target coordinates. To elaborate, the 3D propagation module 214 and the IoD deployment module 204 collaborate to adjust the target coordinates of the plurality of drones in real-time based on the movement of the plurality of vehicles to maintain optimal terrestrial communication coverage. In some exemplary implementations, the 3DIoDAV system framework 200 may use advanced analytics such as machine learning for analysis and implementation. For example, the 3DIoDAV system framework 200 may use a machine learning model to determine and update the first geographical coordinates of each vehicle of the plurality of vehicles based on their movement. Accordingly, the 3D propagation module 214 and the IoD deployment module 204 collaborate to adjust the target coordinates of the plurality of drones in real time based on the updated first geographical coordinates of each vehicle of the plurality of vehicles.

In some examples, the one or more obstacles in the terrain may change. In such instances, the 3D propagation module 214 and the IoD deployment module 204 collaborate to adjust the target coordinates of the plurality of drones in real time based on changes to one or more obstacles to maintain optimal terrestrial communication coverage. In some cases, the vehicles may move in a terrain in which the vehicle may maintain line-of-sight (LoS) or go into non-line-of-sight (NLoS) conditions. The NLOS condition may be due to obstacles or changes in terrain or elevation, etc. In such instances, the 3D propagation module 214 and the IoD deployment module 204 collaborate to deploy the plurality of drones based on the target coordinates. By adjusting drone elevations to balance improved LoS conditions with increased path loss due to greater distances between the drones and the vehicles. As described above, the 3DIoDAV system framework 200 may use advanced analytics to detect obstacles. In an exemplary embodiment, the 3D propagation module 214 and the IoD deployment module 204 collaborate to divide a LoS between a drone of the plurality of drones and a vehicle of the plurality of vehicles into a plurality of prediction points to detect the one or more obstacles affecting signal propagation.

There may be instances where there may path loss due to terrain, geographical conditions, etc. In such instances, the 3D propagation module 214 and the IoD deployment module 204 collaborate to deploy to adjusting elevations of the plurality of drones to balance a trade-off between improved LoS conditions and increased path loss due to greater distances between each drone of the plurality of drones and each vehicle of the plurality of vehicles. In some implementations, the density of vehicles may change. For example, during vacations, the density of vehicles may increase during the morning, when people prefer to travel. The 3DIoDAV system framework 200 is cognitive to such changes to adjust the deployment or placement of drones. In instances based on the varying densities of the vehicles, the 3D propagation module 214 and the IoD deployment module 204 collaborate to adjust and determine the determined target coordinates of each drone of the plurality of drones.

Now consider an example where a delivery truck driving through a city with tall buildings. The tall buildings cause obstacles to communication with other trucks, which is part of the fleet. The elevation estimation module 210 estimates the height of the buildings and the vehicle's current location. The elevation estimation module 210 communicates the estimated information to the obstacle detection module 208. The obstacle detection module 208 recognizes the buildings between the trucks and as obstacles causing signal loss and signal attenuation. In aspects, the signal attenuation is evaluated. Also, dividing a LoS between drones and vehicles into prediction points to detect obstacles affecting signal propagation. Based on the changes to one or more obstacles to maintain optimal terrestrial communication coverage, the IoD deployment module 204 adjusts the target coordinates of the plurality of drones in real-time. In examples, the 3D propagation module 214 may calculate the loss of signal strength as the truck passes through different environments. In account of a varying density of the plurality of vehicles, each drone of the plurality of drones is adjusted to determined target coordinates. Based on the RSSI received at the IoD deployment module 204, the drones are placed in such positions so that there is no signal disruption and the communication is not interrupted. In aspects, the IoD deployment module 204 adjusts the drone elevations to balance improved LoS conditions with increased path loss due to greater distances between the drones and the vehicles. In aspects, the the IoD deployment module 204 places drones such that there is reduced path loss between the vehicle and the drones, or the path loss is prevented. In account of a varying density of the plurality of vehicles, the IoD deployment module 204 adjusts each drone of the plurality of drones to determine target coordinates.

In an exemplary embodiment, the objective function may be an advanced improved particle swarm optimization (IPSO) algorithm that evaluates the quality of different node deployment configurations using the 3D propagation module's signal strength. The iterates through potential IoD node positions and selects the optimal configuration based on the received signal strength (RSS) at vehicle receivers. The objective is to maximize the number of vehicles adequately covered by the network, ensuring strong signal coverage and thus improving the overall connectivity of the VANET. For example, if IoD nodes (read nodes) are deployed along a highway, their signal strength fluctuates due to terrain changes. The 3D propagation module 214 measures the received signal strength at different points, and the IPSO algorithm optimizes the positions of IoD nodes to maximize the number of vehicles with good connectivity. This might involve repositioning or adding more IoD nodes in specific areas, such as deploying a drone at a specific altitude to cover a larger stretch of highway.

In an embodiment, the IPSO algorithm optimizes the placement of IoD nodes in a 3D environment, ensuring strong connectivity for vehicles in challenging environments with varying terrain and obstacles. The aforementioned 3DIoDAV system framework 200 was simulated to determine the effect on VANET connectivity. The simulation resulted in enhanced VANET connectivity and ensured that vehicles remained connected even in areas with poor connectivity due to terrain or obstacles. The approach used terrain elevation, obstacle detection, and a propagation module to simulate real-world scenarios more accurately. Tools like OMNET++, Veins, and SUMO, along with MATLAB for efficient data processing, were used which provided a confirmation of the robust framework for optimizing VANET performance in complex environments.

In an embodiment, the outcome was an optimized deployment of IoD nodes that maximized vehicle coverage, ensuring reliable communication across the network. In real-time applications, this means that vehicles, such as autonomous cars or delivery trucks, can maintain reliable communication with each other and infrastructure, enabling better safety features like collision avoidance, cooperative driving, and real-time traffic updates. The use of tools like SUMO, OMNET++, and Veins, combined with a 3D propagation module, optimized the placement of IoD nodes to ensure continuous, high-quality connectivity, regardless of terrain, obstacles, or vehicle movement. This led to better communication between vehicles, enhancing safety, efficiency, and overall performance of VANETs in possible real-world scenarios.

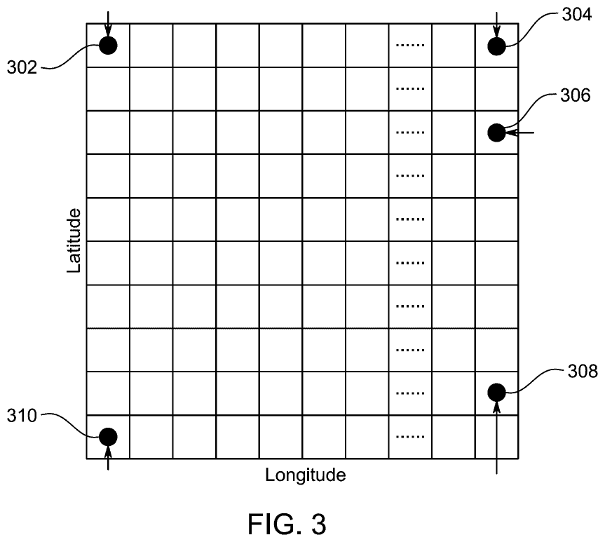

FIG. 3 provides a visual representation of the DEM grid structure. In an embodiment, the DEM is a 2D grid array consisting of 3,601×3,601 cells, each representing an elevation point. The file includes 12,960,601 individual cells, each representing a square grid covering one degree of latitude and longitude. Each cell is a discrete unit with a specific elevation value at a specific geographic location.

In an embodiment, a Universal Transverse Mercator (UTM) system uses easting and northing coordinates to determine the grid's position on Earth's surface. The easting refers to the eastward distance, while the northing is the northward distance. These coordinates help identify each cell in the 2D array, which is then divided into a grid representing a small portion of the terrain.

The FIG. 3 shows a 1-arc second sampling for obtaining elevation data, providing high detail and precision. This unit of angular measurement, equivalent to 30 meters on the ground, is available in two resolutions: 3-arc second and 1-arc second sampling. The 1-arc second resolution in FIG. 3 ensures better accuracy in obtaining accurate elevation data.

In an embodiment, the DEM grid covers one degree of latitude and longitude, dividing an area of 111 kilometres by 111 kilometres near the equator into 3,601×3,601 cells. Each degree of latitude or longitude is represented by 3,601 cells, ensuring uniform division. Elevation data is extracted by pinpointing geographical coordinates to the appropriate grid cell. The grid can be mathematically represented by an N×N matrix, where N=3,601. Each point in this matrix represents the elevation on the Z-axis, simplifying data extraction. The data in the DEM file 212 is visualized in MATLAB using the function geotiffread (DEMfile.tif), which converts the DEM data into a 2D matrix. This matrix stores elevation values for all grid cells, which can be used for further analysis, such as generating a 3D view of the terrain.

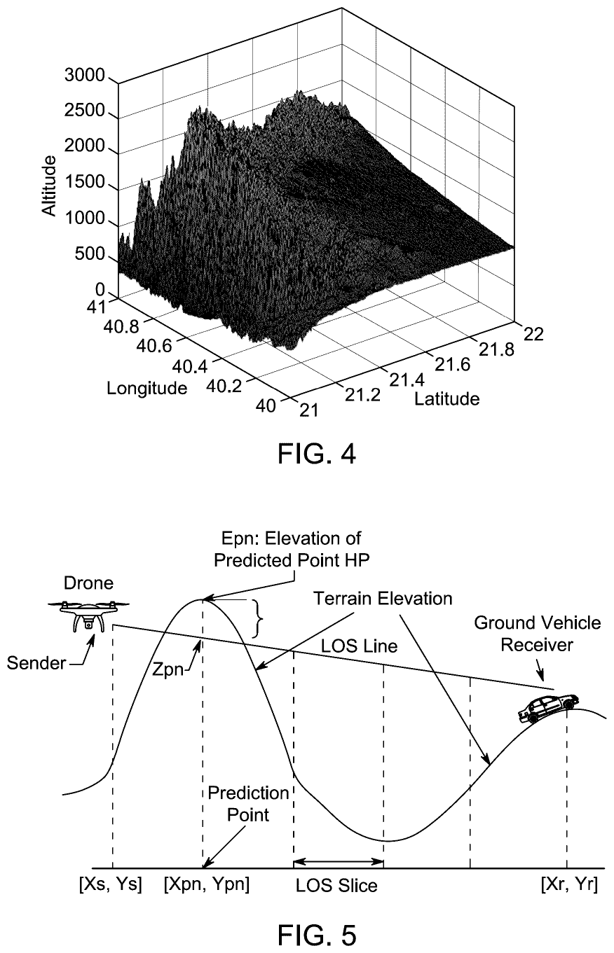

FIG. 4 in the article provides a 3D visualization of an exemplary Road, a mountainous terrain, which helps understand elevation variations across the terrain. The terrain is supportive for analyzing the effects of topography on communication systems, especially those involving the IoD nodes in vehicular networks.

The 3D module in FIG. 4 was created using DEM data and MATLAB software, providing a high-resolution representation of the terrain's elevation data. The high-resolution representation of the terrain's elevation data provided a better understanding of its impact on technical applications like signal propagation and network optimization. The terrain spans elevations between 758 and 2,608 meters, representing a typical mountainous region with significant height differences that could affect communication systems.

The visualization of the exemplary road revealed significant elevation changes, which could affect wireless communication signals. High-elevation areas may cause signal attenuation, while lower valleys may improve reception. This differential in elevation is crucial for designing communication systems requiring aerial or vehicular connectivity in challenging environments, as it influences signal propagation.

The 3D terrain module is crucial for the IoD node application in vehicle communication systems. It highlights how terrain features like mountains, valleys, and slopes affect signal transmission quality between vehicles and aerial drones. Understanding elevation differences allows engineers to optimize drone placement and trajectory, and develop strategies to mitigate issues caused by terrain-induced signal degradation. In the IoD node context, such terrain modules are essential for predicting challenges like signal loss or interference in areas with steep elevation changes and developing countermeasures like strategically placed relay stations or optimized flight paths for drones.

The 3D visualization of the exemplary road terrain, ranging from 758 to 2,608 meters above sea level, reveals significant elevation differences that can impact communication system performance, especially in the context of the IoD technology. Understanding these topographic features can improve the design and efficiency of communication systems, ensuring optimal signal propagation despite the challenging landscape. This visualization is supportive for developing communication infrastructure in similar terrains or integrating drones into vehicular communication systems.

FIG. 5 illustrates that the LoS between a sender and receiver is divided into a set of prediction points for obstacle detection. In an embodiment, signal propagation in communication systems involves transmitting electromagnetic waves from a transmitter to a receiver. In general, the LoS is clear and the signal travels directly, but terrain features like mountains, hills, valleys, and buildings can obstruct this path, reducing or blocking the signal. The RSSI is affected by these terrain obstacles, especially NLOS conditions. In an embodiment, the 3D propagation module 214 aims to accurately assess the extent of terrain-based diffraction and obstacles by predicting and quantifying the effects of these obstacles.

In an embodiment, diffraction is a crucial phenomenon in signal propagation over irregular terrain, where a signal bends around an obstacle to continue propagating beyond it, even if the LoS is obstructed. This bending reduces signal strength, known as signal attenuation. The present disclosure uses the single knife-edge propagation module 206 to approximate this diffraction effect, considering the obstacle as a sharp edge. The signal's attenuation depends on several factors, however, the 3D propagation module 214 assumes the signal bends around the obstacle.

Embodiments of the present disclosure the transmitted signal's wavelength (2) affects its diffractively around obstacles. Longer wavelengths are better at diffracting around obstacles. The height of the obstacle above the LoS increases signal deflection, leading to greater attenuation. The closer the obstacle is to the transmitter or receiver, the more it attenuates the signal due to diffraction.

In an embodiment, the 3D propagation module 214 uses Digital Elevation (DEM) files 212 to extract elevation data for evaluating the impact of terrain features. These files are digital representations of Earth's surface, with each point containing elevation data for a specific coordinate. The 3D propagation module 214 uses this data to determine the precise height of terrain at specific points along the LoS between the transmitter and receiver, detecting and quantifying terrain features that may obstruct or attenuate the signal.

In an embodiment, the LoS is an important aspect of the 3D propagation module 214, as any deviation from this path due to terrain can cause signal loss. In an embodiment, the 3D propagation module 214 divides the LoS into multiple slices or discrete points along the straight line, allowing for better analysis of how each segment interacts with the terrain. Each slice represents a small step along the LoS, where terrain is evaluated for obstructions. To find the coordinates of each slice along the LoS, the 3D propagation module 214 interpolates between the coordinates of the transmitter and receiver in 3D space. For each slice the x, y, and z coordinates are calculated by taking a fraction delta (Δ) of the distance between the transmitter and receiver. These fractions define discrete positions along the LoS where the terrain is analyzed.

In the present disclosure, the equations used to determine the coordinates of a slice are as follows:

$$xp = xs + Δ ( xr - xs ) \qquad ( 1 )$$

$$yp = ys + Δ ( y r - ys ) \qquad ( 2 )$$

$$zp = zs + Δ ( zr - zs ) \qquad ( 3 )$$

where: (xs, ys, zs) are the coordinates of the transmitter, (xr, yr, zr) are the coordinates of the receiver, and A is the fraction of the LoS, ranging from 0 to 1, representing different points along the line.

In the present disclosure, the 3D propagation module 214 assesses if terrain is obstructing the signal path at each slice along the LoS by comparing the terrain elevation from the DEM file 212 to the LoS elevation calculated by zp. The difference between these elevations determines the height of the obstacle at that slice:

$$h p = E p - z p \qquad ( 4 )$$

where Ep is the elevation from the DEM file 212 at the slice point and zp is the elevation of the LoS at the same point.

The present disclosure calculation of hp indicates whether an obstacle above the LoS could interfere with or block the signal, with a positive value indicating an obstacle, and a negative value indicating the terrain does not block the signal at that slice.

In an embodiment, the single knife-edge propagation module 206 is used to calculate signal attenuation caused by obstacles above the LoS. The diffraction effect is influenced by factors such as obstacle height, distance from transmitter and receiver, and signal wavelength. The single knife-edge propagation module 206 calculates signal attenuation based on the diffraction angle and obstacle size relative to the signal wavelength, providing an estimate of the reduction in signal strength due to diffraction.

In another embodiment, the 3D propagation module 214 is useful in rural and mountainous areas, where traditional radio-wave propagation module may be inaccurate. It incorporates terrain data from DEM files 212, providing a more realistic prediction of signal strength and quality. In another embodiment, the 3D propagation module 214 divides the LoS into discrete slices and analyzes each slice based on elevation data, making it effective for detecting and evaluating terrain obstructions. It also uses a single knife-edge propagation module 206 to estimate obstacle impact on signal and predict weak or unreliable communication areas.

In another embodiment, the text describes the 3D propagation module 214, which uses terrain effects to analyze signal propagation in complex terrains. It uses diffraction of the 3D propagation module 214 to estimate signal attenuation around obstacles, extracting precise terrain elevation data from the DEM file 212. In another embodiment, the 3D propagation module 214 divides the LoS into discrete slices, analyzing each slice to identify obstacles above it. If obstacles are present, the single knife-edge propagation module 206 is used to estimate signal attenuation. In another embodiment, this approach provides detailed and realistic assessments of signal propagation in real-world, complex terrains, enabling more accurate and effective communication.

The disclosure describes the IPSO algorithm, inspired by bird flocking or fish schooling, to generate and evaluate potential IoD node positions. The algorithm involves a population of particles moving through the solution space, each adjusting its position based on its previous best position and the best position found by the swarm. Instead of testing every possible location, IPSO explores the space more efficiently by adjusting particles' positions iteratively based on a fitness function.

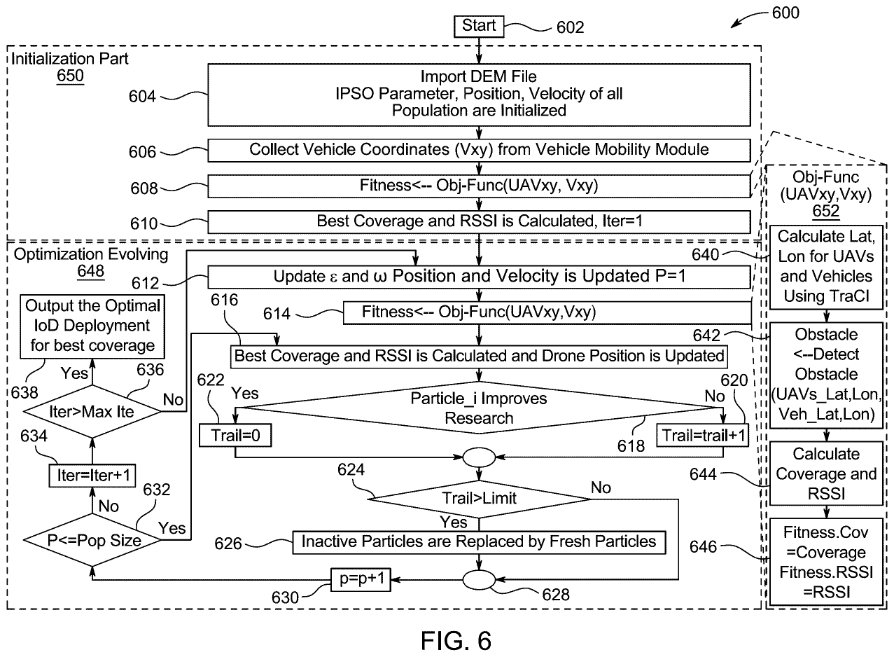

FIG. 6 is the IPSO flow chart 600 for 3D-IoD-assisted VANET. In the present disclosure, the process begins at step 602 with initialization. The initialization includes four elements which is described at step 604, which includes importing the DEM file 212, an IPSO parameter, a position and velocity of all vehicle population in a geographical area. These elements are initialized and sent to step 606. At step 606, the vehicle mobility module 202 collects the vehicle coordinates (Vxy) from the vehicles.

At step 608 fitness is calculated using steps 630-646. In aspects, the fitness may be an objective function. The objective function (dronexy, Vxy) is configured to calculate the latitude and longitude of drones and vehicles in step 640. The objective function (dronexy, Vxy) of step 642 detects obstacles that the vehicles and drones face. The objective function (dronexy, Vxy) in which 644 calculates the coverage in which the drones can collect the data and the RSSI is calculated. Fitness coverage is also calculated by the objective function (dronexy, Vxy) in step 646. In step 608, the vehicle and drone coordinates are calculated, which gives an insight into where the vehicle and drones are present in which latitude and longitude axis. The latitude and longitude of the drones and the vehicles help in detecting the obstacles the vehicle and drones may come across and make it easy to detect the obstacles so as not to lose the network connectivity. With the help of latitude and longitude details, signal strength received, and the coverage of the drones and the vehicles are determined.

To position the drones at the proper places where the signal strength is maximum and can receive more data, in step 610, using the first iteration of fitness, the best coverage and RSSI are calculated. After the completion of the initialization part signal is sent to the optimization evolving. The initialization part is responsible for creating the initial positions and velocities of all the particles in which the drones can achieve maximum coverage and best location by using this algorithm that receives the environmental constraints, obstacles, and all the parameters. Best coverage and the RSSI is achieved by assessing the particle information and solution for each inertia.

The optimization process calculates the number of covered vehicles based on the RSSI values obtained through the optimization process. A vehicle is considered covered if the RSS is above the threshold of −89 dBm, indicating successful communication within the network. The goal is to maximize the number of covered vehicles while ensuring a strong and reliable signal for communication, especially in environments with limited infrastructure. The optimization algorithm can be updated in real-time as vehicles move and terrain conditions change, adjusting the propagation module to maintain desired signal strength. In areas with dense terrain or low signal strength, the system might deploy additional drones or adjust their altitude.

In step 612, by updating an inertia weight (ω) and Epsilon (ε), the position and velocity and velocity of each solution is updated. Then in step 614, the fitness generated solution is evaluated. In step 616, the best coverage and RSSI is updated. Thereby the drone position is updated. In step 618, particle_i improves the research. Here if the particle_i research improves the research then then the flow moves to step 622, that is trail is equal to zero or if the particle_i research doesn't improve the research then the flow moves to step 620, that is trail is equal to trail plus 1. In step 624, if trail is greater than the limit, the inactive particle is replaced by new fresh particle in step 626, if not position plus is performed in step 630. If the updated position and velocity is less than the population size then start the process step 616, again from step 612 and if updated position and velocity is not less than the population size then in step 634 iteration plus 1 process is done and is sent to step 636 iteration is checked if its greater than the maximum iteration or not. If the iteration value is less than the maximum iteration value, then send the signals again to 612 when the position and velocity is updated. If the iteration value is greater than the maximum iteration. In step 638, the output of the optimal IoD deployment for best coverage is obtained.

In this embodiment, the focus is on the dynamic deployment of IoD nodes in 3D spaces, considering terrain obstacles. The IPSO is efficiently used to find optimal positions for IoD nodes, ensuring maximum coverage and signal strength as it is crucial for real-world applications where terrain can impact communication performance. The IoD network ensures autonomous vehicles receive necessary data for safe travel, even in challenging environments. The cost-effective and time-efficient solution for deploying the drones in real-time ensures maximum coverage and signal strength. The system 200 could be used in areas like autonomous vehicle fleets, smart highways, or emergency response operations in hard-to-reach locations. The optimization strategy offers a scalable and efficient solution for modern transportation systems, particularly in challenging terrain.

In the present disclosure, the simulation uses a terrain map from OpenStreetMap, which directly influences signal propagation and vehicle communication. The terrain affects LOS and LoS communication parameters, such as terrain roughness. Elevation information from SRTM DEM informs parameters like obstacle height and terrain profile, which can impact signal strength and coverage between vehicles. These changes can be modelled in the simulations to ensure accurate and reliable communication.

In the present disclosure, the simulation durations for simulation 1 (1,040 seconds) and simulation 2 (600 seconds) are likely to be listed in Table 1 under parameters related to simulation time, which dictate the duration of the vehicles and the communication model's behavior over time.

In an example, the basic safety message (BSM) in VANETs is 1.4 kilobyte (kB) in size and type, as specified in Table 1. It is used for safety and alerting vehicles about hazards and may include information on message frequency and expiration time, as it is used for safety and important information.

TABLE 1

| | |
|---|---|
| Parameter | Value |

| Geographical Range | 6000 − m × 8000 − m | |
|---|---|---|
| Propagation Model | 3D Propagation Model | |
| Frequency | 5.9 | GHz |
| IoD size | [1, 2, 3, 4, 5, 6, 7, 8, 9, 10] UAVs | |
| minPowerLevel | −89 | dBm |
| Optimization Approach | IPSO | |
| Population Size | 50 | |
| Maximum Iteration | 50 | |
| Packet Size | 1.4 | KB |
| Message Type | BSM | |
| sending rate | 1 | Hz |
| Update Interval | 10 | s |

Simulation 1 Parameters Setting

| Deployment Altitude | [30, 50, 100, 150, 200, 250, 300]m | |
|---|---|---|
| Transmission Power | 50 − mW | |
| Simulation Time | 1,040 | s |

Simulation 2 Parameters Setting

| Deployment Altitude Range | [50 − m to 100 − m ] and | |
|---|---|---|
| | [100 − m to 150 − m ] | |
| Transmission Power | [20, 40, 60, 80]mW | |
| Simulation Time | 600 | s |

In the present disclosure, the packet size of the BSM is 1.4 kB, which is likely listed in Table 1. The sending rate is crucial for timely updates in the dynamic environment of VANETs. The update interval indicates how frequently the network or vehicles update their communication parameters, affecting the responsiveness of the VANET. The frequency used for communication is essential for the IoD, with higher frequencies allowing faster data transmission but also posing interference or attenuation, especially in mountainous environments. Table 1 likely specifies the communication frequency used in simulations.

In the present disclosure, the two simulations test the IoD2V communication model in mountainous terrain and the 3DIoDAV approach in improving the VANET performance. Additional parameters like the communication model type and specific objectives like signal strength evaluation and vehicle connectivity are listed in Table 1, which may include additional parameters related to these objectives.

In the present disclosure, the IoD network's effectiveness in simulation is evaluated by its coverage, which is the percentage of connected vehicles relative to the total number of vehicles. The formula for calculating coverage is Vcon/Vt, where Vcon represents the number of connected vehicles and Vt represents the total number of vehicles. Table 1 likely includes parameters for tracking vehicle connectivity over time.

In the present disclosure, the obstacles in mountainous terrain, such as hills or buildings, can affect communication signal propagation. Table 1 provides details on terrain types and their impact on signal propagation models. It could also discuss how obstacles' height affects signal strength or signal-to-noise ratio in the propagation model.

In the present disclosure, the Table 1 provides an exemplary list of key simulation parameters, including terrain characteristics, communication parameters, vehicle connectivity metrics, and simulation durations, essential for testing the 3DIoDAV approach in mountainous rural environments and ensuring the IoD2V communication model operates effectively in challenging conditions. These details are derived from existing studies to ensure simulation settings are grounded in practical, real-world conditions.

In an embodiment, the section evaluates the 3D propagation module 214 for IoD2V communication and compares it with a 2D propagation module, focusing on how terrain elevation affects coverage and reliability of communication between drones and ground vehicles compared to the 2D propagation module.

In an embodiment, the evaluation uses two drone altitudes (50 meters and 200 meters) to observe the module's behavior in different deployment scenarios and environmental conditions. It compares two modules: a 3D propagation module 214 that considers terrain elevation, and a 2D propagation module that simplifies terrain without vertical variation. The evaluation also uses the single knife-edge propagation module 206 to simulate radio waves diffracting around obstacles, assessing how diffraction affects the range and quality of communication. Both modules are crucial for understanding the communication module's effectiveness.

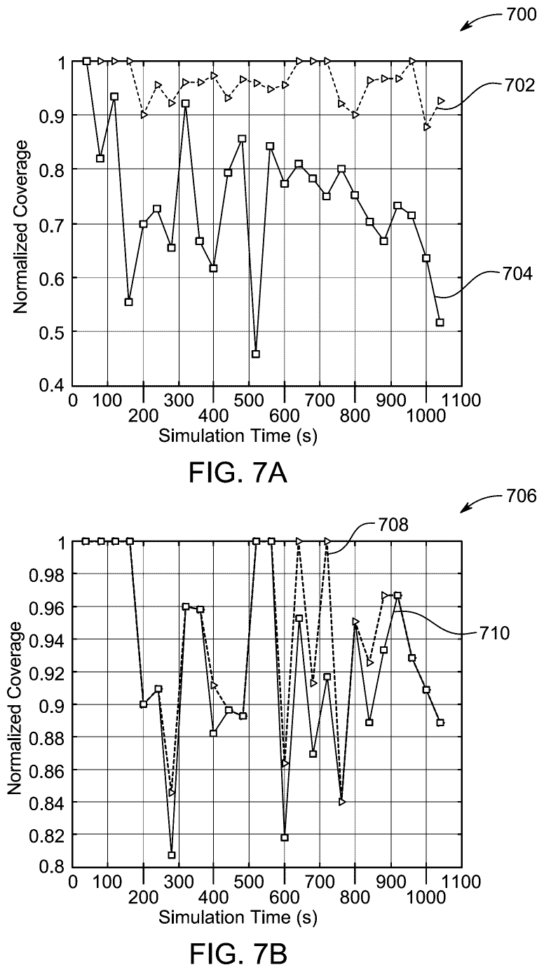

FIG. 7A illustrates the graphical representation 700 of at 50 meters (m) altitude; terrain elevation significantly impacts drone communication, as drones are more likely to be obstructed by terrain, causing issues with ground vehicles. The 3D propagation module 214 obtains result 704, which only covers 77.4% of vehicles, compared to 96.5% in the 2D propagation module, which obtains result 702, highlighting the significant impact of terrain elevation on communication quality and coverage in lower altitude deployments.

FIG. 7B illustrates the graphical representation 706; the simulation results show that at 200-meter altitude, the LoS condition is satisfied, allowing drones and vehicles to communicate without interruption. There is no significant difference between the 3D propagation module 214, which obtains result 710, and the 2D propagation module, which obtains result 708, for most simulation times (280, 400, 600 seconds). However, the 3D propagation module 214 obtains result 710 has slightly lower coverage due to terrain obstacles, resulting in reduced signal obstruction and vehicle loss.

In the present disclosure, the evaluation of the 3D propagation module 214 obtains results 704 and 710 based on its ability to accurately represent the impact of terrain on communication. It is more realistic than the 2D propagation module and obtains results 702 and 708, which may work well for idealized scenarios, especially when drones fly at lower altitudes. In the present disclosure, the 3D propagation module 214 obtains results 704 and 710, illustrating reduced coverage due to terrain obstacles, reflecting real-world conditions where elevation changes affect signal propagation. This makes it a better representation of IoD2V communication, particularly in complex environments with varying terrain elevations.

In an embodiment, the terrain obstructions are a significant factor in real-world scenarios, as they can cause signal shadowing or diffraction. The 3D propagation module 214 obtains results 704 and 710 that accurately simulate these physical phenomena, showing how terrain elevations reduce communication range and coverage. For example, a drone trying to communicate with a vehicle on the other side of a large hill would not cause issues in the 2D propagation module, obtaining results 702 and 708, as the terrain would block the signal, resulting in a lower percentage of vehicles being covered.

For instance, drones navigate terrain in disaster relief operations, where broken buildings, collapsed roads, and uneven terrain can significantly obstruct communication. If drones fly at a higher altitude, the terrain might not significantly obstruct their communication with vehicles or rescue teams on the ground. However, if the drone is deployed at a lower altitude, the terrain can severely obstruct communication, leading to lower coverage and isolated vehicles or ground units.

In the present disclosure, the 3D propagation module 214 obtains results 704 and 710, offers a more accurate and useful simulation, which is essential for designing robust communication systems for IoD2V in diverse terrains. By considering the impact of terrain on communication, the 3D propagation module 214 obtains results 704 and 710, providing a more realistic representation of the conditions drones might face in real-world environments.

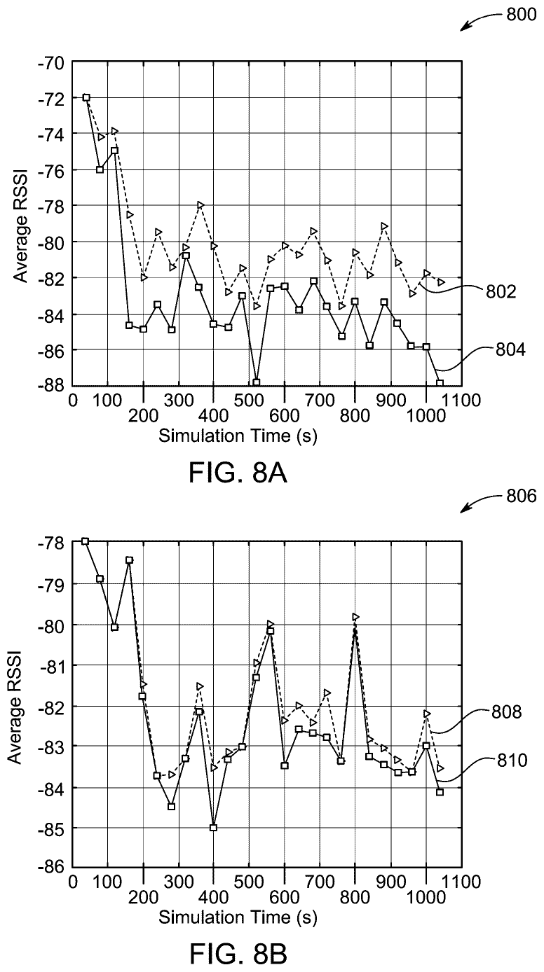

FIGS. 8A and 8B illustrates the section that discusses the 3D propagation module 214 behavior and its comparison with a 2D propagation module for vehicle coverage at various altitudes.

In the present disclosure, the 3D propagation module 214 performance is analyzed using average RSSI measurements over time. Results are shown in FIGS. 8A and 8B, corresponding to different altitudes of 50 m and 200 m, and at specific simulation times.

FIG. 8B illustrates the graphical representation 806 that at 200 m altitude, the RSSI drops significantly at simulation times 280, 400, and 600 s, with a significant drop at 400 s due to high terrain obstructing the signal. This results in reduced vehicle coverage and signal loss. The significant loss occurs at 400 s due to the terrain being higher than the signal path, causing more attenuation and reducing the signal's reach. The 3D propagation module 214 obtains result 810, and the 2D propagation modules obtains result 808, showing similar RSSI values at times other than 400 s, suggesting that terrain doesn't significantly impact signal propagation.

The signal is typically subjected to the NLOS condition for lower altitude deployment, specifically at 50 m, as present in FIG. 8A illustrates the graphical representation 800, 3D propagation module 214 obtains result 804, and 2D propagation modules obtain result 802.

The present disclosure 3D propagation module 214 exhibits a significant drop in the signal intensity (RSSI) at 520 s, compared to the 2D propagation module's −83.7 dBm. This is due to the higher sensitivity to terrain, which plays a crucial role in signal propagation. The terrain can block or obstruct the signal more effectively in a 3D environment, leading to higher signal loss compared to a simpler 2D propagation module. This highlights the importance of elevation in signal propagation.

In the present disclosure, the 3D propagation module 214 emphasizes the role of elevation in signal propagation, highlighting that terrain can create significant interference and reduce signal strength (RSSI) at lower altitudes. The 2D propagation module, however, doesn't account for these obstructions effectively, resulting in a more consistent RSSI. The 3D propagation module 214 provides a more accurate representation of real-world conditions, confirming the significant impact of elevation and terrain on signal strength.

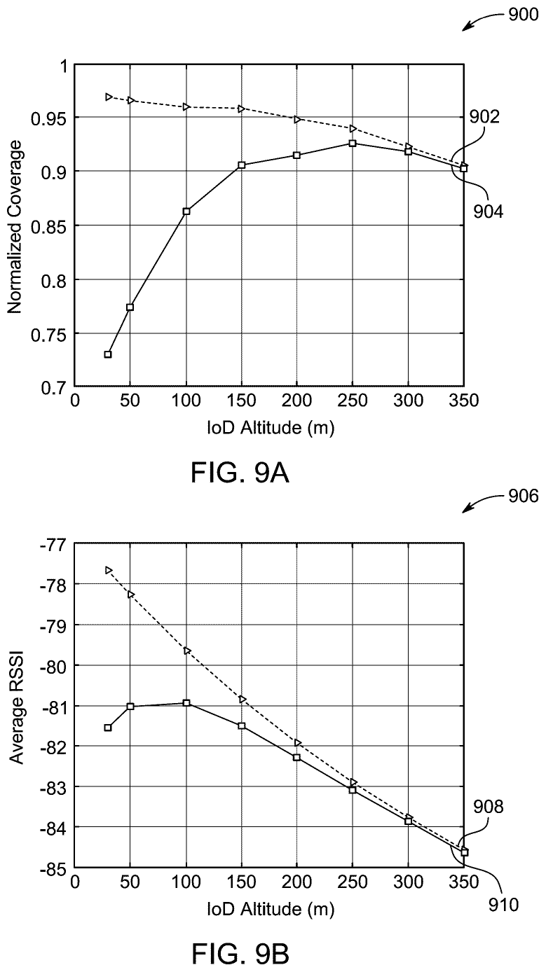

FIG. 9A and FIG. 9B illustrate the passage and discuss the influence of deployment altitude on the communication performance of an IoD system in vehicular networks, specifically IoD2V.

The present disclosure discusses the impact of altitude on the performance of the IoD2V communication system, focusing on the deployment of IoD nodes at different altitudes from 30 m to 300 m. The performance is evaluated using the RSSI and normalized coverage. The present disclosure discusses that as altitude increases, the connectivity of the VANET improves, enhancing the ability of vehicles on the ground to communicate with drone.

The optimal altitude for deployment is 250 m, where the IoD nodes have a clear LoS to ground vehicles, which is critical for reliable communication. In an embodiment, the LoS condition reduces interference and obstacles, leading to a stronger and more consistent signal.

However, any further increase in altitude results in a decrease in coverage and signal quality. This is because the distance between the IoD nodes and ground vehicles increases, leading to higher path loss, which negatively impacts the received signal strength and coverage. The embodiment contrasts this 3D propagation module (IoD2V) 214 with the traditional 2D propagation module, which relies on the horizontal distance between the sender (IoD node) and receiver (vehicle).

In an embodiment, the 3D propagation module, factors such as LoS, altitude, and path loss are considered, leading to the identification of an optimal deployment altitude. The research concludes that there is a specific optimal altitude for deploying IoD nodes that maximizes both coverage area and RSSI, ensuring the best communication performance by balancing LoS, path loss, and distance effects.

The IoD system may be used in smart cities to enhance road safety and traffic management and provide real-time data to vehicles. In a smart city, autonomous vehicles are equipped with communication systems that allow them to interact with infrastructure, other vehicles, and the drones flying overhead. The IoD system can facilitate this by creating a wireless communication network with vehicles on the ground, relaying important data such as traffic conditions, accidents, or road blockages. A delivery drone is used for traffic monitoring and delivery services, providing real-time data to nearby vehicles.

In an embodiment, the altitude of the drones impacts communication performance between the drones and the autonomous vehicles on the road.

FIG. 9A illustrates the graphical representation 900, the RSSI and coverage area are key to ensuring strong and reliable communication. FIG. 9A illustrates the graphical representation 900 in which 2D is represented as 902 and 3D propagation module is represented as 904. A low altitude (30 m-50 m) allows the drones to directly communicate with vehicles on the road, but it is more susceptible to interference from buildings, trees, and other obstacles. A medium altitude (100 m-150 m) improves the Line of Sight, allowing the drones to communicate more effectively with vehicles. An optimal altitude (250 m) maximizes coverage area and RSSI, allowing more vehicles to receive data. However, a high altitude (300 m and above) results in more path loss, decreased RSSI, and decreased coverage area, causing communication delays or gaps.

In the present embodiment the optimal deployment of RSSI may not accurately represent the optimal value, as present in FIG. 9B illustrates the graphical representation 906. FIG. 9B illustrates the graphical representation 906 in which 2D is represented as 908 and 3D propagation module is represented as 910.

The present disclosure highlights the importance of deployment altitude in maximizing communication performance in IoD2V systems. It suggests that an optimal altitude of around 250 meters is necessary for optimal communication coverage and signal strength. Lower altitudes may result in signal degradation due to interference from buildings and trees, resulting in lower RSSI and a smaller coverage area. At optimal altitudes, the drones experience improved LOS and a balance between signal strength and coverage area, providing better coverage and larger coverage for communication with multiple vehicles. However, at higher altitudes, the increasing distance between the drones and vehicles results in higher path loss, reducing the effectiveness of communication.

The present disclosure findings are relevant in smart cities where the drones used for traffic monitoring and vehicle communication need to find the optimal altitude for effective data transmission. High altitudes may result in poorer communication performance due to increased path loss, while low altitudes may face interference from physical obstacles, resulting in weaker communication. Therefore, finding the optimal altitude is crucial for maximizing coverage and signal strength for communication between drones and vehicles in a smart transportation system.

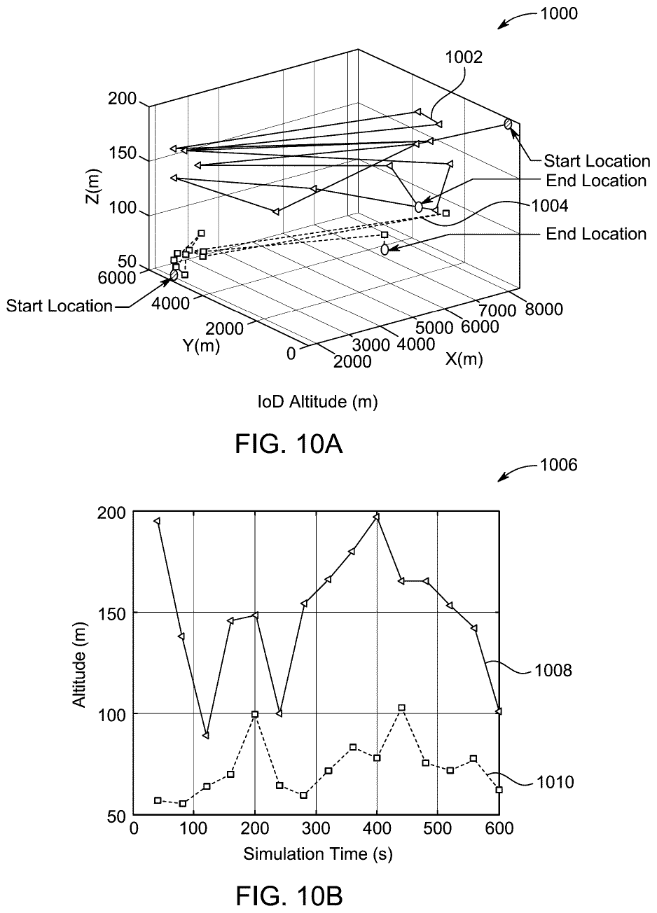

FIG. 10A and FIG. 10B discuss an experiment comparing a 3D propagation module 214 for drone deployment to a 2D module in terms of coverage and received signal strength for IoD communication systems.

The present disclosure investigates the performance of a 3D propagation module 214 for IoD systems by recording the optimal locations of two drone, representing IoD size. The optimal locations are determined using IPSO implementation during simulations. The optimal drone paths are generated by both 2D and 3D modules, with altitudes varied between 50-200 meters to understand their impact on communication performance.

In an embodiment, the simulation results FIG. 10A illustrate the graphical representation 1000 depicts that the optimal path for drones in both the 2D propagation module obtained result 1004 and the 3D propagation module 214 obtained result is the path with the best coverage and RSSI. The present disclosure emphasizes the importance of dynamically deploying the drones to improve signal quality and coverage. In the 2D propagation module, the module neglects terrain variations, leading to paths that do not account for elevation changes. In an embodiment, the 3D propagation module 214, the module incorporates terrain elevation, allowing drones to be deployed at altitudes and locations that optimize LoS sight conditions, reducing potential signal disruptions caused by obstacles. The drones are dynamically deployed and adjusted in real-time to avoid nLoS conditions.

In the present disclosure, the behavior of drones in 3D propagation module 214 and 2D propagation module differs significantly due to the account of terrain elevation in 3D propagation module 214. The 3D propagation module 214 suggests that drones should be deployed at higher altitudes in 3D space to improve communication, especially when terrain elevation creates obstacles in lower altitudes. The 3D propagation module 214 allows the drones to adjust their altitude dynamically throughout the simulation to enhance signal quality and improve LoS with ground vehicles.

In the present disclosure, the number of connected vehicles provides better coverage across a larger area. In contrast, the 2D module, which ignores terrain elevation, shows drones flying at lower altitudes, resulting in lower-quality communication in real-world scenarios where terrain elevation may cause obstructions.

FIG. 10B illustrates the graphical representation 1006 which compares drone altitudes in 2D propagation module result obtained 1010 and 3D propagation module 214 result obtained 1008 after removing terrain information. Results show that in the 3D propagation module 214, drones fly higher altitudes to overcome terrain obstacles and maintain a clear line of sight with ground vehicles, improving signal quality. Conversely, in the 2D propagation module, the absence of terrain information leads to lower altitudes, potentially reducing performance in real-world situations where terrain might obstruct signal paths.

The 2D propagation module and 3D propagation module 214 are crucial in the deployment of drones in an IoD network. In a real-time scenario, a fleet of drones is deployed to provide internet coverage in mountainous regions like the Swiss Alps or the Rocky Mountains. In an embodiment, the system ensures reliable communication between drones and vehicles traveling through the terrain. The 2D propagation module considers the entire landscape as flat, with the drones deployed at a constant altitude calculated based on this flat surface. The drones follow pre-calculated, flat paths to optimize coverage.

For instance, the drones may fly at 100 meters above the ground at all times. In contrast, the 3D propagation module 214 considers actual terrain features, such as mountains and valleys, and deploys drones at dynamic altitudes, which change as they move to different locations. The system optimizes the altitude and position to avoid obstacles and maintain a good LoS for the vehicles on the ground. In the 2D module, the drones are deployed at an altitude of 100 meters above the ground, following a direct path along the road the vehicles are traveling on. However, as the terrain changes, the drones may fly too low or be obstructed by the mountains, resulting in poor signal quality or loss of connection for the vehicles.

In an embodiment, the 3D propagation module 214, the drones are aware of the terrain and adjust their altitude dynamically. As the vehicles approach a valley, the drones might climb to a higher altitude to avoid a mountain that would otherwise obstruct the signal. In the 3D propagation module 214, the drones also adjust their path to maintain LoS with the ground vehicles. In mountainous regions, the drones might deviate from a straight path in the 2D propagation module to avoid tall mountain peaks. This dynamic adjustment helps keep the received signal strength stable and high, crucial for maintaining effective communication links for the vehicles in motion. In an embodiment, the 2D and 3D propagation modules play a significant role in the deployment of drones in IoD networks, ensuring reliable communication and minimizing the impact of terrain variations.

The present disclosure, 3D propagation module 214, offers a more realistic and effective deployment strategy for drones in an IoD network. It considers terrain elevation and allows the drones to adjust altitudes dynamically, ensuring optimal communication in areas with irregular terrain. This module achieves better signal quality and coverage compared to the 2D module, which does not account for terrain variations. The 3D module leads to more reliable communication in real-world environments.

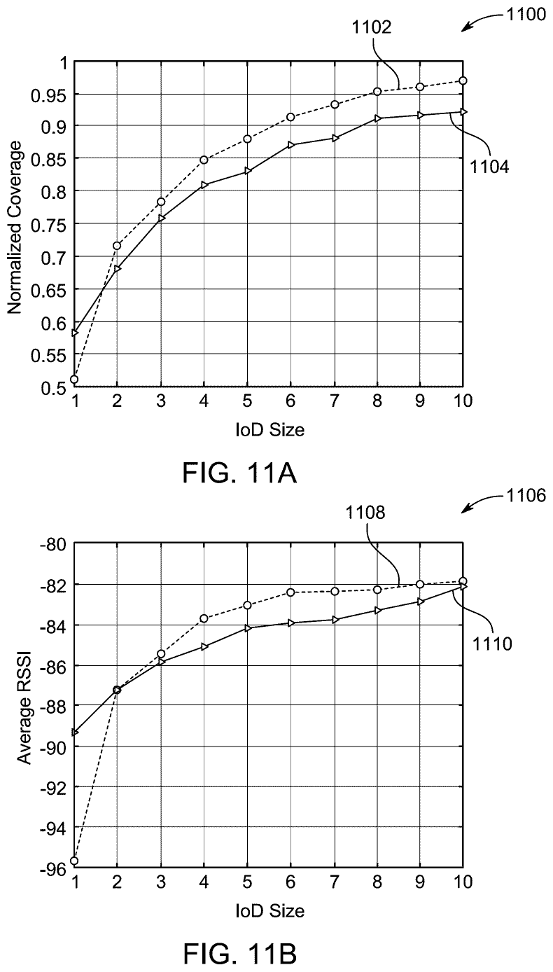

FIG. 11A and FIG. 11B illustrate the effects of the size IoD on the connectivity and RSSI of a VANET. In present disclosure, the integration of IoDs with VANET enhances overall connectivity between vehicles and drone, with a constant transmission power of 80 mW. Larger IoD sizes improve coverage, with the increase proportional to the number of drones seen in the simulation results, FIG. 11A illustrates the graphical representation 1100. However, diminishing returns occur when the IoD size becomes too large, as increasing the number of drones could lead to interference and collisions, negatively impacting the network's performance. To prevent redundancy and interference, the drones are configured to maintain an adequate distance from each other.

In an embodiment, where drones are deployed to manage emergency situations, such as natural disasters, in a large city, they are integrated into a VANET to facilitate communication between ground vehicles and other emergency services. The VANET connectivity with IoD is initially limited due to the small number of drones at low altitudes (50-100 m) 1104, which can lead to weak signal strength due to the distance between drones and vehicles. As more drones are added to the network, the coverage area expands, and the connectivity improves. As more drones are added, the coverage area expands, ensuring that emergency vehicles can communicate even in areas where the LoS is obstructed. The drones at higher altitudes provide better coverage because they fly above the terrain, with fewer obstructions they encounter. However, there could be issues of interference or collision between the drones, especially if they are too close to each other. Altitude considerations in IoD deployment include low altitude (50-100 m) 1104, where the drones are closer to the vehicles on the ground, creating NLoS conditions, which could lead to disruptions in the communication between the drones and ground vehicles. High altitude (100-150 m) 1102, increases the chances of having a clear LoS condition, and the signal can travel longer distances without obstruction. The RSSI with IoD size also plays a role in the effectiveness of the system. With more drones, the quality of the received signal increases significantly, especially in the higher altitude range (100-150 m) 1102, where the LoS condition improves, and the terrain has a lesser impact on communication.

In an embodiment, 3DIoDAV further, the effect of IoD size on RSSI is examined. The RSSI is specifically measured in relation to simulation time, and the average RSSI is calculated in relation to. FIG. 11B, illustrates the graphical representation 1106, provides an illustration of IoD size. When there is only one drone covering the target area, the quality of the received signal is low, as shown in this figure, and it improves as the number of drones increases. Because terrain has less of an effect on IoD2V communication when drones fly at higher altitudes, improving the LoS condition, this is more beneficial in the 100-150 m, 1108 altitude range than it is in the 50-100 m altitude range, 1110.

In an embodiment, the importance of the number of IoD nodes (drones) in improving VANET connectivity and signal strength (RSSI). However, there are trade-offs between increased coverage and potential interference and collisions. Altitude also impacts communication quality, with higher altitudes providing better LoS conditions but increasing path loss. The optimal number of drones and altitude ranges depend on balancing coverage improvement and minimizing communication hindrances caused by terrain and interference. In real-time scenarios, optimizing the number of drones and altitude is crucial for maintaining effective communication in dynamic environments like emergency response scenarios.

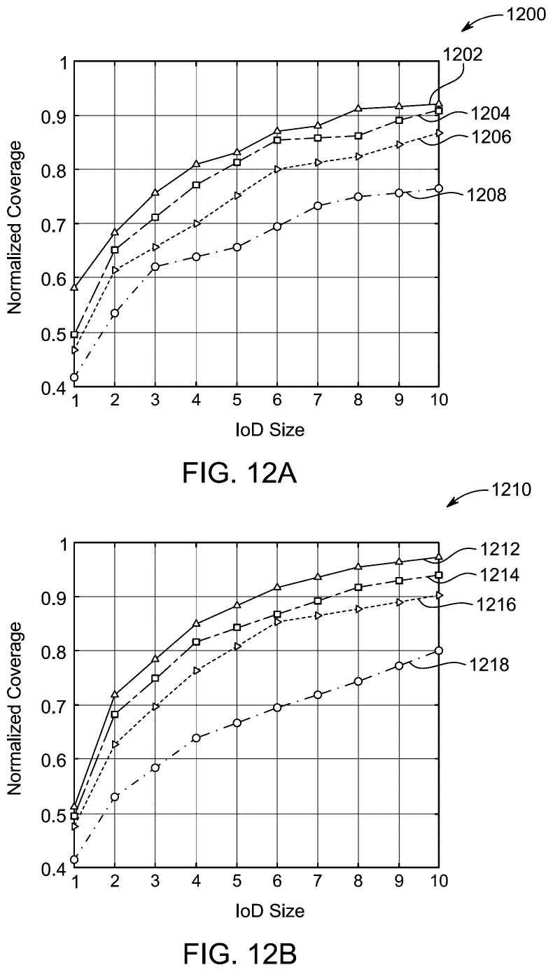

FIG. 12A and FIG. 12B illustrate the influence of transmission power on coverage and RSSI in the context of the 3DIoDAV system, focusing on how varying power from drone affects total coverage and signal quality in a VANET.

The present disclosure describes the impact of transmission power on normalized coverage across two altitude ranges: 50-100 m and 100-150 m. Normalized coverage refers to the proportion of vehicles covered by drone, adjusted for the total area of interest, with higher coverage indicating more vehicles within the network's reach.

In the present disclosure a direct correlation between power transmission and coverage, indicating that as the transmission power increases, so does the coverage. In FIG. 12A illustrates the graphical representation 1200 (altitude range of 50-100 m), coverage increases from 76.4% to 92.2% with 10 drones. FIG. 12A illustrates the graphical representation 1200 in which different transmission power is represented 20 Megawatt (mW) as 1208, 40 mW as 1206, 60 mW as 1204, 80 mW as 1202.

In an embodiment, FIG. 12B illustrates the graphical representation 1210 (altitude range of 100-150 m), coverage increases from 79.8% to 99.1% for the same power levels and drone number. This is due to the larger area covered by the signal. FIG. 12B illustrates the graphical representation 1210 in which different transmission power is represented: 20 Megawatt (mW) as 1218, 40 mW as 1216, 60 mW as 1214, and 80 mW as 1212.

The FIG. 12B illustrates the graphical representation 1210 reveals that higher transmission power (higher altitude, 100-150 m) leads to significantly larger coverage than in scenario 1, with a 99.1% coverage rate in scenario 2, indicating that drones are more efficient at covering larger areas at higher altitudes.

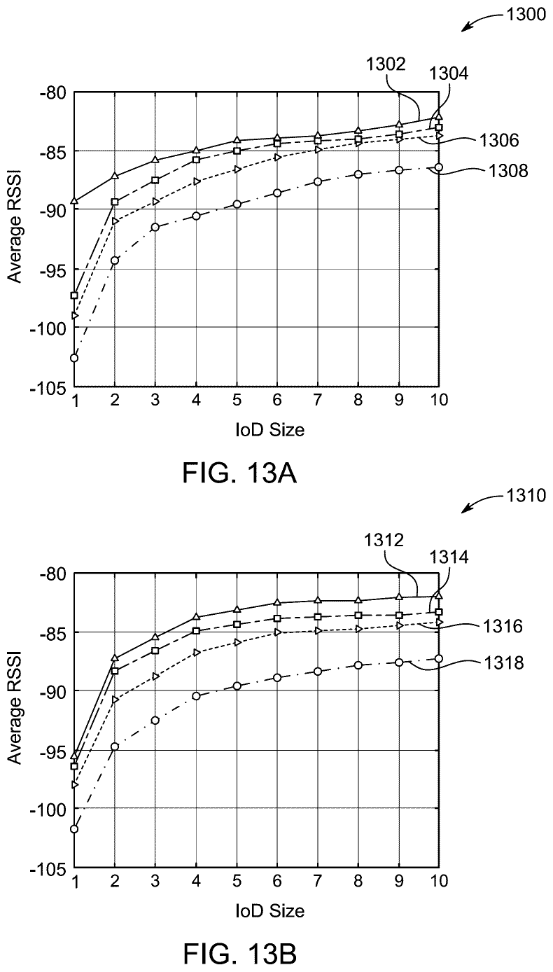

In the present disclosure the strength of the received signal, known as RSSI, significantly impacts the quality of communication in a VANET. FIGS. 13A and 13B indicates that as transmission power increases for both altitude ranges, signal quality and communication reliability also improve.

FIG. 13A illustrates graphical representation 1300 average RSSI for different transmission power values with respect to different IoD sizes in 3DIoDAV for 50-100 m deployment altitude. FIG. 13A illustrates the graphical representation 1300 in which different transmission power is represented 20 (mW) as 1308, 40 mW as 1306, 60 mW as 1304, 80 mW as 1302.

FIG. 13B illustrates a graphical representation of 1310 average RSSI for different transmission power values with respect to different IoD sizes in 3DIoDAV for 100-150 m deployment altitude. FIG. 13B illustrates the graphical representation 1310 in which different transmission power is represented 20 (mW) as 1318, 40 mW as 1316, 60 mW as 1314, 80 mW as 1312.

In an embodiment, urban areas, a company may use delivery drones (drone) as part of a VANET to deliver packages to customers. The drones communicate with ground vehicles and each other to ensure efficient coordination and delivery. The impact of transmission power on coverage varies depending on the altitude of the drone. In an embodiment, for low altitudes, the drones transmit 20 mW of power level 1208, which limits their communication range. As the transmission power increases to 40 mW of power level 1206, 60 mW of power level 1204, 80 mW of power level 1202, the normalized coverage rises to 86.2%, reducing the chances of missed deliveries. If the power is further increased to 80 mW power level 1202, the coverage could increase to 92.2%, allowing almost all delivery vehicles to communicate with the drones efficiently.

FIG. 12B illustrates a graphical representation of 1210, high altitudes, presents around 100-150 meters, and increases the transmission power even more significantly, resulting in 99.1% coverage, allowing almost every delivery vehicle in the network to communicate with the drone. This increases the coverage and reliability of the received signal, especially in urban environments with obstacles like buildings.

FIG. 12A illustrates graphically representation 1200, which would present that at 20 mW power level as 1208, only 76.4% of the targeted delivery vehicles are within range to receive the drone's signal. Real-time benefits of higher transmission power include improved delivery efficiency, better signal quality in urban settings, and scalability. As the delivery fleet grows, the system can scale without significantly impacting network performance, ensuring that drones can communicate effectively across a larger area.

In an embodiment, FIGS. 12A and 12B, FIGS. 13A and 13B that higher transmission power significantly improves the performance of the VANET by increasing coverage and signal quality. This highlights the importance of adjusting transmission power to ensure comprehensive and reliable communication across the network. The relationship between transmission power, coverage, and RSSI directly applies to drone operation in a VANET. Increasing transmission power leads to more efficient communication, reduced delays, and better overall service. In an embodiment, highlights the need for effective management of transmission power in urban delivery systems and other applications involving the drones and vehicle networks.

The present disclosure validates the 3DIoDAV method by comparing it with the 2D propagation module and the known IoDAV modules by Ahmed G. A. et al. (2021), assessing its performance in realistic conditions and its ability to handle terrain elevation's effect on communication performance.

The present disclosure uses average normalized coverage and RSSI as key performance metrics for evaluating the IoD communication system. These metrics reflect the system's coverage area and signal strength, crucial for maintaining reliable connections between IoD and ground vehicles. Higher normalized coverage indicates a larger area of successful IoD coverage, while higher RSSI values indicate stronger signals at receivers, such as the drones or ground vehicles, contributing to better communication reliability. Both metrics are essential for evaluating the IoD's performance.

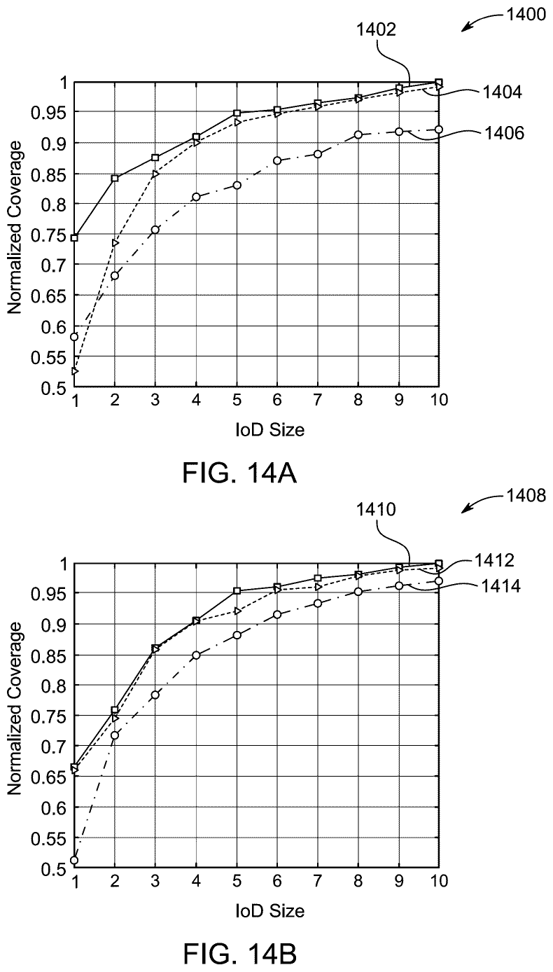

The present disclosure validates 3DIoDAV by comparing it with 2D propagation modules and IoDAV modules, which are commonly used for IoD communication systems but neglect terrain elevation. FIGS. 14A and 14B show that as IoD size increases, coverage improves across all modules, but 3DIoDAV consistently provides lower coverage due to its explicit factoring in terrain elevation, which reduces signal propagation, especially in areas with varying topography like hills or valleys. This difference is crucial for understanding the real-world propagation of radio signals.

FIG. 14A illustrates graphical representation 1400, an average normalized coverage for different IoD sizes in 3DIoDAV, 2D, and IoDAV approaches for 50-100 m deployment altitude. In an embodiment, FIG. 14A illustrates the graphical representation 1400 in which different different IoD sizes in 3DIoDAV as 1406, 2D as 1402, and IoDAV as 1404 approaches for 50-100 m deployment altitude is represented.

FIG. 14B illustrates graphical representation 1408, average normalized coverage for different IoD sizes in 3DIoDAV, 2D, and IoDAV approaches for 100-150 m deployment altitude. In an embodiment, FIG. 14B illustrates the graphical representation 1408 in which different different IoD sizes in 3DIoDAV as 1414, 2D as 1410, and IoDAV as 1412 approaches for 100-150 m deployment altitude is represented.

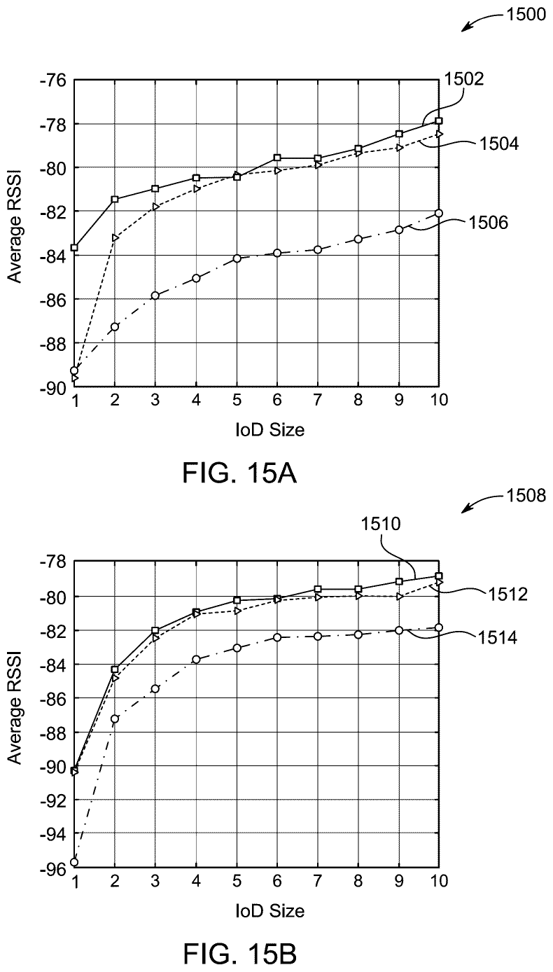

FIGS. 15A and 15B show average RSSI values for scenario 1 and scenario 2, with 2D and IoDAV modules yielding higher values due to their inability to account for terrain elevation's impact, resulting in an unrealistic view of signal strength. The 3DIoDAV, on the other hand, produces more conservative values by considering terrain effects.

FIG. 15A illustrates graphical representation 1500, average RSSI for different sets of drones in the 3DIoDAV, 2D, and IoDAV approaches for 50-100 m deployment altitude. In an embodiment, FIG. 15A illustrates the graphical representation 1500 in which different different IoD sizes in 3DIoDAV as 1506, 2D as 1502, and IoDAV as 1504 approaches for 50-100 m deployment altitude is represented.

FIG. 15B is an illustration average RSSI for different sets of drones in the 3DIoDAV, 2D, and IoDAV approaches for 100-150 m deployment altitude. In an embodiment, FIG. 15B illustrates the graphical representation 1508 in which different different IoD sizes in 3DIoDAV as 1514, 2D as 1510, and IoDAV as 1512 approaches for 100-150 m deployment altitude is represented.

In an embodiment, the 3DIoDAV stands out from other modules due to its consideration of terrain elevation, which affects radio signals in real-world applications. The module considers how topography influences signal propagation, making its results more reliable in real-world applications. The results show that the 3DIoDAV performs better at higher altitudes, particularly in scenario 2, where higher altitudes improve LoS conditions between IoD nodes and ground vehicles. This is due to the drone's ability to see farther and less likely to be obstructed by terrain features, resulting in improved coverage and RSSI values. The relationship between altitude and communication quality is crucial, as drones often operate at varying altitudes depending on mission requirements. The findings emphasize the importance of selecting appropriate altitudes for the drones to optimize the communication system.

In the present disclosure, plot average normalized coverage and RSSI as a function of transmission power for ten different IoD sizes in both scenarios. They show that the 2D and the IoDAV approaches show better coverage and RSSI compared to the 3DIoDAV, but these modules do not accurately reflect real-world conditions. The 3DIoDAV yields lower coverage and RSSI values due to terrain elevation, but these results are more realistic and account for the limitations of communication in landscapes with varying elevations.

The present disclosure discusses the deployment of IoD nodes using the 3DIoDAV, which can optimize node placement by considering terrain features. They run the 2D simulation to predict optimal node locations and evaluate them using the 3DIoDAV approach. The 3DIoDAV approach leads to better deployment due to its ability to detect terrain obstacles and place nodes in locations where signal propagation is less hindered by physical terrain features. Although it yields lower performance metrics like coverage and RSSI, 3DIoDAV accounts for terrain elevation, making it a more realistic and effective approach for IoD communication, especially in diverse topography environments. The embodiment also presents that 3DIoDAV can optimize IoD node deployment to mitigate terrain effects and improve overall communication performance.

In a real-time scenario, the drones can be deployed for disaster relief operations in mountainous regions, where terrain is highly variable and can create significant obstacles to wireless communication. The 2D propagation module suggests that the drones can maintain communication with ground vehicles across vast distances, assuming ideal signal propagation in all directions. However, this assumption is unrealistic as the signal strength would be significantly reduced in such areas, especially when flying at lower altitudes. The IoDAV approach considers some aspects of terrain but typically treats the communication environment in a simplified manner. It might incorporate basic terrain effects, such as terrain elevation at a coarse level, but does not fully module complex terrain obstacles like ridges or deep valleys that may significantly influence signal propagation. This results in less realistic predictions.

In an embodiment, using the 3DIoDAV approach, drones that fly at lower altitudes in valleys or behind hills would experience significant signal attenuation and coverage loss due to the obstructions. In such areas, RSSI values would be much lower because the radio waves would be blocked by the mountains or heavily reduced by the terrain. However, when the drones fly at higher altitudes, the LoS condition improves, and the signal strength increases, leading to better communication. The module might also recommend optimal deployment of the drones to ensure they are positioned at altitudes and locations that minimize the effects of terrain obstacles, improving overall communication reliability. In the real-world disaster relief scenario, the 3DIoDAV approach offers the most realistic and effective communication performance by accurately modeling terrain elevation and its impact on signal propagation. While the 2D and the IoDAV modules might suggest ideal communication conditions, they fail to account for the challenges posed by mountainous terrain, resulting in less reliable predictions. In contrast, 3DIoDAV predicts lower coverage and RSSI values in obstructed areas, but it also provides practical insights into how to optimize drone placement and flight altitudes for effective communication, leading to more reliable drone-based communication networks in challenging real-world environments like mountainous regions.

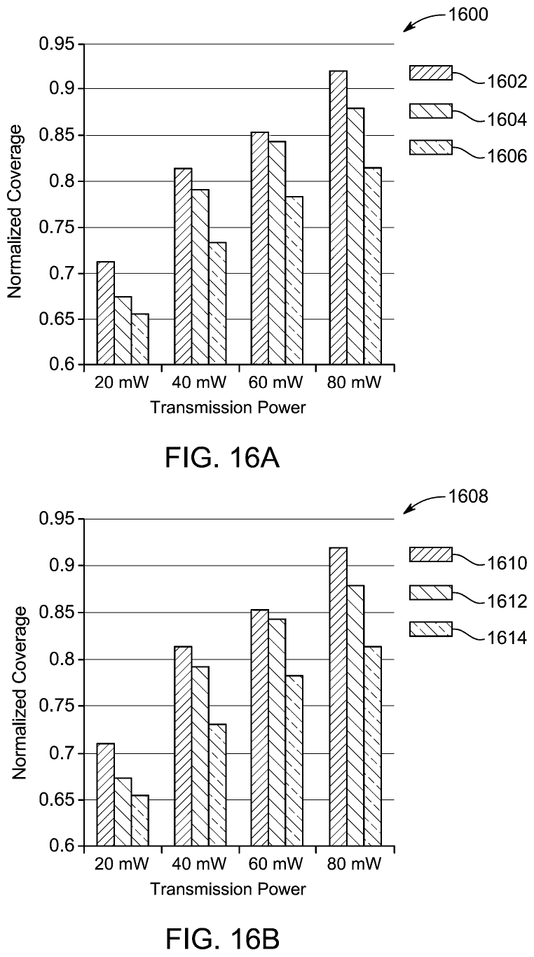

FIG. 16A illustrates a graphical representation 1600 of average normalized coverage in the 3DIoDAV, 2D, and IoDAV approaches for different transmission power values for 10 drones for 50-100 m deployment altitude. FIG. 16A illustrates the graphical representation 1600 in which different IoD sizes in 3DIoDAV as 1606, 2D as 1602, and IoDAV as 1604 approach for 50-100 m deployment altitude is represented.

FIG. 16B illustrates a graphical representation 1608 of average normalized coverage in the 3DIoDAV, 2D, and IoDAV approaches for different transmission power values for 10 drones for 100-150 m deployment altitude. In an embodiment, FIG. 16B illustrates the graphical representation 1608 in which different IoD sizes in 3DIoDAV as 1614, 2D as 1610, and IoDAV as 1612 approaches for 50-100 m deployment altitude is represented.

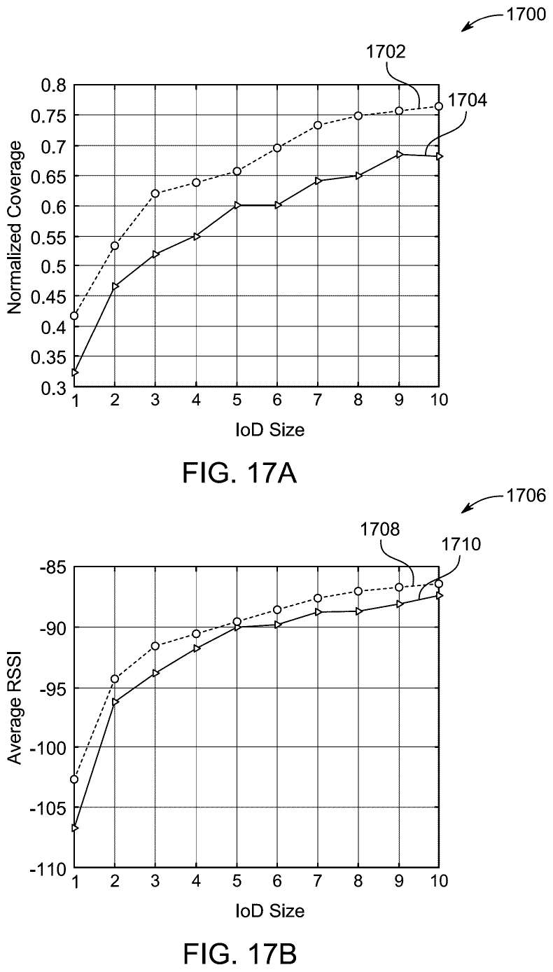

In an embodiment, the reference compares two approaches for determining optimal locations for Internet of Devices nodes in Vehicular Ad Hoc Networks (VANETs), as shown in FIGS. 17A and 17B. The present disclosure compares two methods for determining optimal locations for IoD nodes in VANETs. It focuses on normalized coverage and RSSI metrics, which measure the area covered by IoD nodes and their distribution. Higher coverage indicates better node distribution, while higher RSSI indicates stronger connectivity and communication between devices, ensuring reliability and quality of communication.

FIG. 17A illustrates a graphical representation 1700 of 2D and 3D IoD deployment evaluated by 3DIoDAV for different sets of drones for average normalized coverage. FIG. 17A illustrates graphical representation 1700 illustrates 2D deployment as 1704 and 3D deployment as 1702.

FIG. 17A illustrates graphical representation 1706 of 2D and 3D IoD deployment evaluated by 3DIoDAV for different sets of drones for average RSSI, according to certain embodiments. FIG. 17B illustrates graphical representation 1706 illustrates 2D deployment as 1710 and 3D deployment as 1708.

The present disclosure reveals that the 3DIoDAV approach outperforms the 2D propagation module in terms of normalized coverage and RSSI, as it considers a 3D, considering the height of nodes, their positioning within a realistic 3D environment, and other physical factors influencing signal propagation. This approach allows for more strategically optimal placement of IoD nodes in more realistic environments, such as urban landscapes.

In the present disclosure, the 3DIoDAV approach is more effective in placing IoD nodes for better coverage and signal strength, demonstrating its advantage in adapting to real-world environments more accurately than the 2D approach. This enhances VANET's performance, providing better connectivity and reliable communication for the network, thereby enhancing its adaptability to the complexity of real-world environments.

In the present disclosure, the 2D propagation module and the 3DIoDAV approach are two modules used to compare the placement of IoD nodes in a smart city. The 2D module assumes a flat, 2D environment, treating the IoD nodes as uniformly placed on flat rooftops. This results in weaker signals in areas with different terrain or obstacles, making communication performance less efficient. The 3DIoDAV approach incorporates a three-dimensional perspective, considering both horizontal and vertical distances for the IoD nodes. This allows for more realistic placement in real-world urban environments where buildings and roads are not flat and have varying elevations.

For instance, placing nodes on tall buildings or elevated highways ensures that even vehicles on lower roads can maintain strong connections. The 3DIoDAV approach also accounts for the movement of vehicles, positioning nodes dynamically as needed to ensure strong and reliable communication. Key benefits of the 3DIoDAV approach include higher coverage, better RSSI (signal strength), and better coverage in complex areas with obstructions. In a city with varying terrains, autonomous vehicles will have consistent coverage, even if traveling through complex areas with obstructions. By considering the 3D environment, the IoD nodes are placed in positions where signal propagation is optimized, providing stronger signals over longer distances. In real-world scenarios, the 3DIoDAV approach reduces the chances of lost connections or delays in communication by ensuring reliable communication with other vehicles and infrastructure.

In the present disclosure, by deploying the IoD nodes at the most appropriate locations determined by the 3DIoDAV approach, the embodiment presents a notable improvement in the performance of VANETs, making the network more efficient and reliable. By implementing the 3DIoDAV approach in a smart city with VANET, the system ensures that the IoD nodes are strategically positioned to maximize coverage and signal strength. The positioning improves real-time communication in complex urban environments, allowing vehicles to maintain seamless, low-latency communication even in areas with tall buildings, hills, tunnels, or other obstacles. In contrast, the simpler 2D propagation module would likely struggle to provide the same level of performance, especially in more challenging environments. Thus, by applying the 3DIoDAV approach, cities can enhance the efficiency and reliability of VANETs, contributing to the smooth functioning of autonomous vehicles and the overall smart city infrastructure.

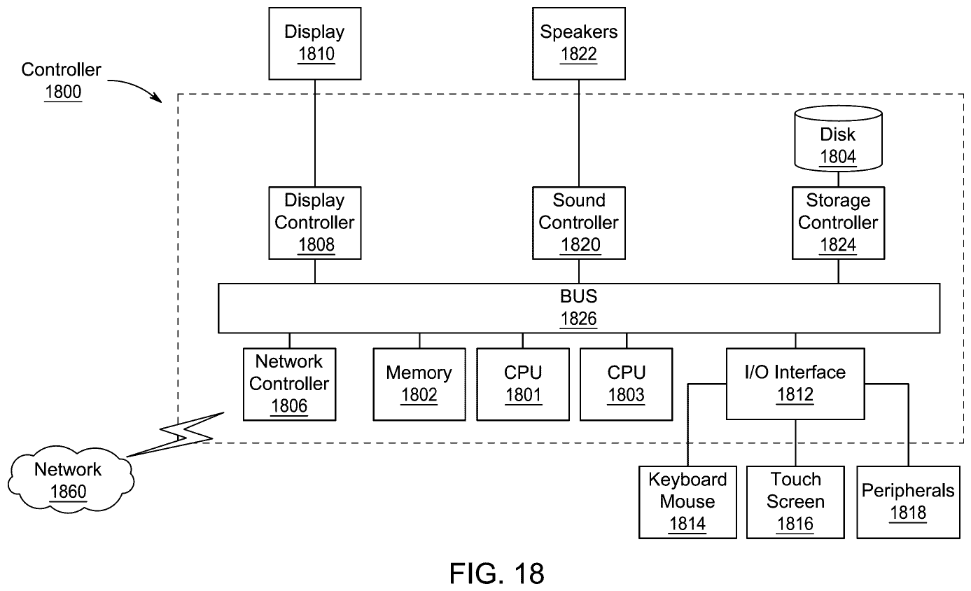

Next, further details of the hardware description of the computing environment according to exemplary embodiments is described with reference to FIG. 18. In FIG. 18, a controller 1800 is described as representative of the UAV detection system in which the controller 1800 is a computing device which includes a Central Processing Unit (CPU) 1801 which performs the processes described above/below. The process data and instructions may be stored in a memory 1802. These processes and instructions may also be stored on a storage medium disk 1804 such as a Hard Disk Drive (HDD) or a portable storage medium or may be stored remotely.

Further, the claims are not limited by the form of the computer-readable media on which the instructions of the inventive process are stored. For example, the instructions may be stored on Compact Disks (CDs), Digital Versatile Discs (DVDs), in a Flash memory, a Random Access Memory (RAM), a Read-Only Memory (ROM), a Programmable Read-Only Memory (PROM), an Erasable Programmable Read-Only Memory (EPROM), an Electrically Erasable Programmable Read-Only Memory (EEPROM), a hard disk or any other information processing device with which the computing device communicates, such as a server or a computer.

Further, the claims may be provided as a utility application, background daemon, or component of an operating system, or combination thereof, executing in conjunction with the CPU 1801, a CPU 1803 and an operating system such as a Microsoft Windows 7, a Microsoft Windows 10, a UNIX, a Solaris, a LINUX, an Apple MAC-OS and other systems known to those skilled in the art.

The hardware elements in order to achieve the computing device may be realized by various circuitry elements, known to those skilled in the art. For example, the CPU 1801 or the CPU 1803 may be a Xenon or a Core processor from Intel of America or an Opteron processor from Advanced Micro Devices (AMD) of America, or may be other processor types that would be recognized by one of ordinary skill in the art. Alternatively, the CPU 1801, the CPU 1803 may be implemented on a Field-Programmable Gate Array (FPGA), an Application-Specific Integrated Circuit (ASIC), a Programmable Logic Device (PLD) or using discrete logic circuits, as one of ordinary skill in the art would recognize. Further, the CPU 1801, the CPU 1803 may be implemented as multiple processors cooperatively working in parallel to perform the instructions of the inventive processes described above.

The computing device in FIG. 18 also includes a network controller 1806, such as an Intel Ethernet Professional (PRO) network interface card from an Intel Corporation of America, for interfacing with a network 1860. As can be appreciated, the network 1860 can be a public network, such as the Internet, or a private network such as a Local Area Network (LAN) or a Wide Area Network (WAN), or any combination thereof and can also include a Public Switched Telephone Network (PSTN) or an Integrated Services Digital Network (ISDN) sub-networks. The network 1860 can also be wired, such as an Ethernet network, or can be wireless such as a cellular network including EDGE, Third Generation (3G) and Fourth Generation (4G) wireless cellular systems. The wireless network can also be a WiFi, a Bluetooth, or any other wireless form of communication that is known.

The computing device further includes a display controller 1808, such as a NVIDIA GeForce Giga Texel Shader eXtreme (GTX) or a Quadro graphics adaptor from a NVIDIA Corporation of America for interfacing with a display 1810, such as a Hewlett Packard HPL2445w Liquid Crystal Display (LCD) monitor. A general purpose I/O interface 1812 interfaces with a keyboard and/or mouse 1814 as well as a touch screen panel 1816 on or separate from display 1810. The general purpose I/O interface 1812 also connects to a variety of peripherals 1818 including printers and scanners, such as an OfficeJet or DeskJet from HP.

A sound controller 1820 is also provided in the computing device such as a Sound Blaster X-Fi Titanium from Creative, to interface with speakers/microphone 1822 thereby providing sounds and/or music.

A general-purpose storage controller 1824 connects the storage medium disk 1804 with a communication bus 1826, which may be an Industry Standard Architecture (ISA), an Extended Industry Standard Architecture (EISA), a Video Electronics Standards Association (VESA), a Peripheral Component Interconnect (PCI), or similar, for interconnecting all of the components of the computing device. A description of the general features and functionality of the display 1810, keyboard and/or mouse 1814, as well as the display controller 1808, the general-purpose storage controller 1824, the network controller 1806, the sound controller 1820, and the general purpose I/O interface 1812 is omitted herein for brevity as these features are known.

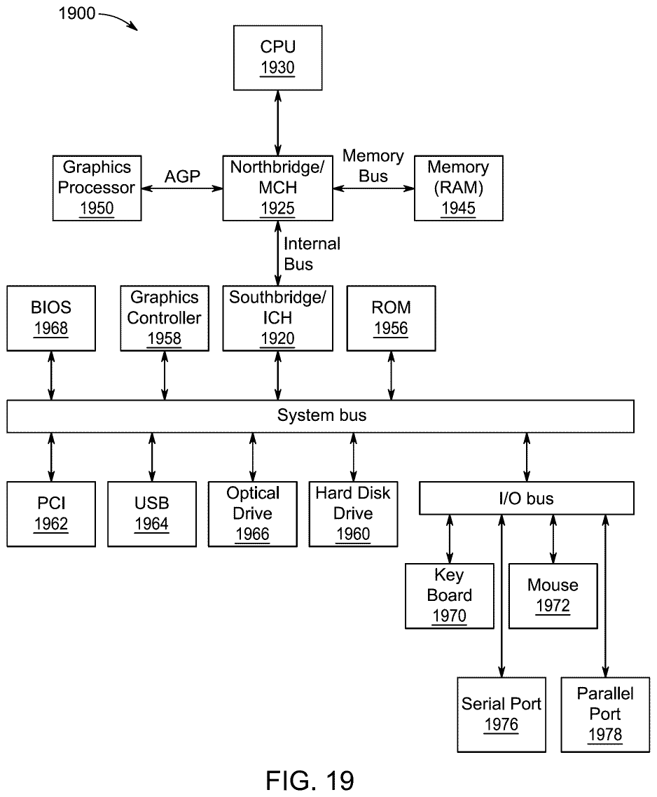

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 19.

FIG. 19 shows a schematic diagram of a data processing system 1900, according to certain embodiments, for performing the functions of the exemplary embodiments. The data processing system 1900 is an example of a computer in which code or instructions implementing the processes of the illustrative embodiments may be located.

In FIG. 19, the data processing system 1900 employs a hub architecture including a North Bridge and a Memory Controller Hub (NB/MCH) 1925 and a south bridge and an Input/Output (I/O) Controller Hub (SB/ICH) 1920. The CPU 1930 is connected to the NB/MCH 1925. The NB/MCH 1925 also connects to a memory 1945 via a memory bus and connects to a graphics processor 1950 via an Accelerated Graphics Port (AGP). The NB/MCH 1925 also connects to the SB/ICH 1920 via an internal bus (e.g., a unified media interface or a direct media interface). The CPU 1930 may contain one or more processors and may even be implemented using one or more heterogeneous processor systems.

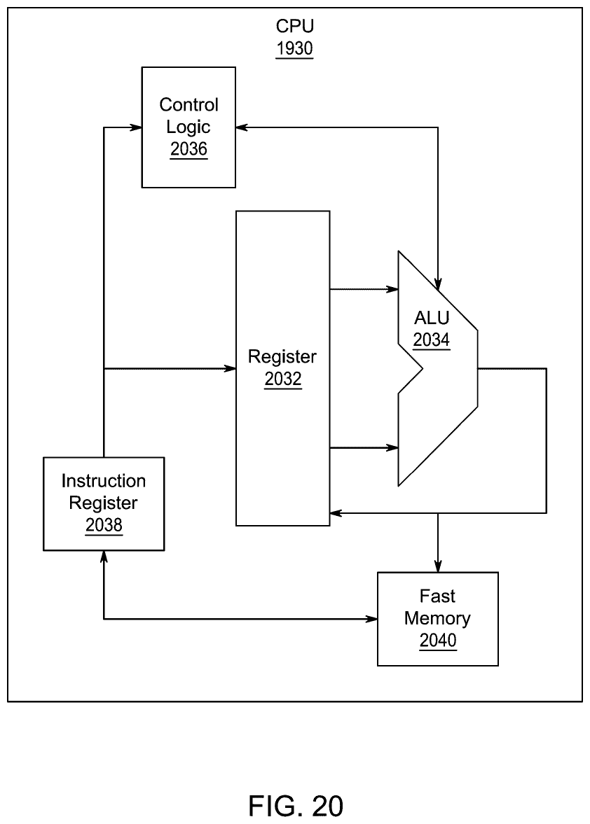

For example, FIG. 20 shows one implementation of the CPU 2030. In one implementation, an instruction register 2038 retrieves instructions from a fast memory 2040. At least part of these instructions is fetched from the instruction register 2038 by a control logic 2036 and interpreted according to the instruction set architecture of the CPU 2030. Part of the instructions can also be directed to a register 2032. In one implementation, the instructions are decoded according to a hardwired method, and in another implementation, the instructions are decoded according to a microprogram that translates instructions into sets of CPU configuration signals that are applied sequentially over multiple clock pulses. After fetching and decoding the instructions, the instructions are executed using an Arithmetic Logic Unit (ALU) 2034 that loads values from the register 2032 and performs logical and mathematical operations on the loaded values according to the instructions. The results from these operations can be feedback into the register 2032 and/or stored in the fast memory 2040. According to certain implementations, the instruction set architecture of the CPU 2030 can use a reduced instruction set architecture, a complex instruction set architecture, a vector processor architecture, a very large instruction word architecture. Furthermore, the CPU 2030 can be based on a Von Neuman model or a Harvard model. The CPU 2030 can be a digital signal processor, a Field-Programmable Gate Array (FPGA), an Application-Specific Integrated Circuit (ASIC), a Programmable Logic Array (PLA), a Programmable Logic Device (PLD), or a Complex Programmable Logic Device (CPLD). Further, the CPU 2030 can be an x86 processor by the Intel or by the AMD; an Advanced Reduced Instruction Set Computing (RISC) Machine (ARM) processor, a power architecture processor by, e.g., an International Business Machines Corporation (IBM); a Scalable Processor Architecture (SPARC) processor by Sun Microsystems or by Oracle; or other known CPU architecture.

Referring again to FIG. 19, the data processing system 1900 can include that the SB/ICH 1920 is coupled through a system bus to an I/O Bus, a ROM 1956, a Universal Serial Bus (USB) port 1964, a flash Binary Input/Output System (BIOS) 1968, and a graphics controller 1958. Peripheral Component Interconnect/Peripheral Component Interconnect Express (PCI/PCIe) devices can also be coupled to SB/ICH 888 through a PCI bus 1962.

The PCI devices may include, for example, Ethernet adapters, add-in cards, and Personal Computer (PC) cards for notebook computers. The HDD 1960 and an optical drive 1966 (e.g., CD-ROM) can use, for example, an Integrated Drive Electronics (IDE) or a Serial Advanced Technology Attachment (SATA) interface. In one implementation, an I/O bus can include a super I/O (SIO) device.

Further, the HDD 1960 and the optical drive 1966 can also be coupled to the SB/ICH 1920 through a system bus. In one implementation, a keyboard 1970, a mouse 1972, a serial port 1976, and a parallel port 1978 can be connected to the system bus through the I/O bus. Other peripherals and devices that can be connected to the SB/ICH 1920 using a mass storage controller such as the SATA or a Parallel Advanced Technology Attachment (PATA), an Ethernet port, an ISA bus, a Low Pin Count (LPC) bridge, a System Management (SM) bus, a Direct Memory Access (DMA) controller, and an Audio Compressor/Decompressor (Codec).

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or on the requirements of the intended back-up load to be powered.

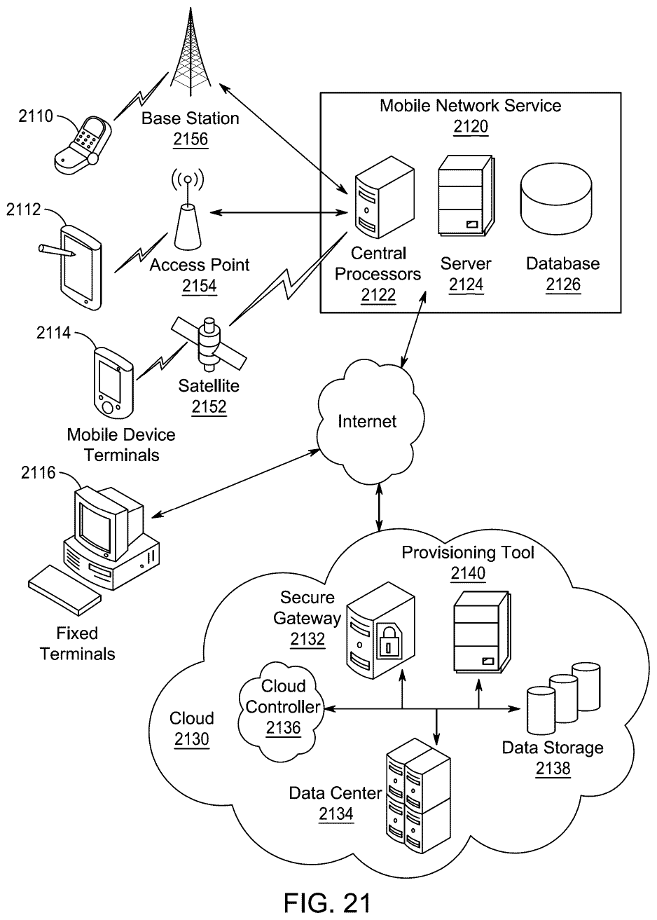

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 21, in addition to various human interface and communication devices (e.g., display monitors, smart phones, tablets, personal digital assistants (PDAs)). More specifically, FIG. 21 illustrates client devices including a smart phone 2111, a tablet 2112, a mobile device terminal 2114 and fixed terminals 2116. These client devices may be commutatively coupled with a mobile network service 2120 via a base station 2156, an access point 2154, a satellite 2152 or via an internet connection. The mobile network service 2120 may comprise central processors 2122, a server 2124 and a database 2126. The fixed terminals 2116 and the mobile network service 2120 may be commutatively coupled via an internet connection to functions in cloud 2130 that may comprise a security gateway 2132, a data center 2134, a cloud controller 2136, a data storage 2138 and a provisioning tool 2140. The network may be a private network, such as the LAN or the WAN, or may be the public network, such as the Internet. Input to the system may be received via direct user input and received remotely either in real-time or as a batch process. Additionally, some implementations may be performed on modules or hardware not identical to those described. Accordingly, other implementations are within the scope that may be disclosed.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

The invention claimed is:

1. A method for a terrestrial communication on a three-dimensional internet of drone (IoD)-assisted vehicle ad-hoc network including a plurality of drones and a plurality of vehicles, comprising:
obtaining first geographical coordinates of each vehicle of the plurality of vehicles;
estimating a first elevation of each vehicle of the plurality of vehicles at the first geographical coordinates;
obtaining second geographical coordinates of each drone of the plurality of drones;
detecting one or more obstacles between a first vehicle of the plurality of vehicles and a second vehicle of the plurality of vehicles based on the geographical coordinates and the first elevation;
determining a signal attenuation based on the first geographical coordinates, the second geographical coordinates, and the one or more obstacles with a propagation module;
evaluating the signal attenuation based on an objective function to determine target coordinates of each drone of the plurality of drones;
deploying the plurality of drones based on the target coordinates; and
facilitating the terrestrial communication on the three-dimensional IoD-assisted vehicle ad-hoc network.

2. The method of claim 1, wherein the propagation module includes a single knife-edge propagation model.

3. The method of claim 2, wherein the single-knife edge propagation model determines the signal attenuation based on a Fresnel-Kirchhoff diffraction parameter.

4. The method of claim 1, wherein the method is repeated as the first geographical coordinates of the plurality of vehicles change.

5. The method of claim 1, wherein the facilitating the terrestrial communication further comprises facilitating communication between the plurality of vehicles and the plurality of drones, the plurality of drones acting as relay nodes.

6. The method of claim 1, wherein the propagation module determines received signal strength at the plurality of vehicles by accounting for signal attenuation caused by terrain features.

7. The method of claim 1, further comprising adjusting the target coordinates of the plurality of drones in real-time based on movement of the plurality of vehicles to maintain optimal terrestrial communication coverage.

8. The method of claim 1, further comprising adjusting the target coordinates of the plurality of drones in real-time based on changes to the one or more obstacles to maintain optimal terrestrial communication coverage.

9. The method of claim 1, further comprising
determining, using a machine learning model, updated first geographical coordinates of the each vehicle of the plurality of vehicles; and
adjusting the target coordinates of the plurality of drones in real-time based on the updated first geographical coordinates of the each vehicle of the plurality of vehicles.

10. The method of claim 1, wherein the evaluating the signal attenuation based on the objective function further comprises
obtaining a received signal strength indicator (RSSI) at a receiving vehicle; and
determining a terrestrial communication coverage based on the RSSI and the target coordinates of each drone of the plurality of drones.

11. The method of claim 10, wherein the evaluating the signal attenuation based on the objective function further comprises
setting a minimum power-level threshold;
determining the terrestrial communication coverage based on the RSSI and the minimum power-level threshold, wherein a vehicle of the plurality of vehicles is defined as covered when the RSSI is greater than the minimum power-level threshold.

12. The method of claim 1, wherein terrain elevation data including the first elevation of the each vehicle of the plurality of vehicles is obtained from a digital elevation model (DEM) to define a terrain profile.

13. The method of claim 1, further comprising adjusting the target coordinates of the each drone of the plurality of drones based on line-of-sight (LoS) and non-line-of-sight (NLoS) conditions.

14. The method of claim 13, further comprising adjusting elevations of the plurality of drones to balance a trade-off between improved LoS conditions and increased path loss due to greater distances between each drone of the plurality of drones and the each vehicle of the plurality of vehicles.

15. The method of claim 1, further comprising dividing a LoS between a drone of the plurality of drones and a vehicle of the plurality of vehicles into a plurality of prediction points to detect the one or more obstacles affecting signal propagation.

16. The method of claim 1, wherein the determined target coordinates of each drone of the plurality of drones is adjusted to account for a varying density of the plurality of vehicles.

17. A system of a three-dimensional internet of drone (IoD)-assisted vehicle ad-hoc network, comprising:
a vehicle mobility module;
an IoD deployment module communicatively connected to the vehicle mobility module; and
a three-dimensional propagation module, comprising:
an elevation estimation module;
an obstacle detection module; and
a single knife-edge propagation module; and
processing circuitry configured to
perform the method of claim 1, wherein
the three-dimensional propagation module is communicatively connected to the IoD deployment module and the vehicle mobility module.

18. The system of claim 17, wherein the single-knife edge propagation model determines the signal attenuation based on a Fresnel-Kirchhoff diffraction parameter.

19. The system of claim 17, wherein the method is repeated as the first geographical coordinates of the plurality of vehicles change.

20. The system of claim 17, wherein the propagation module determines received signal strength at the plurality of vehicles by accounting for signal attenuation caused by terrain features.
